(19) United States
(12) Patent Application Publication
(10) Pub. No.: US 2023/0224235 A1
(43) Pub. Date: Jul. 13, 2023

(54) Network Topology Construction Method and Apparatus, and Computer Readable Medium

(71) Applicants: Siemens Aktiengesellschaft, München (DE); SIEMENS LTD.,, Beijing (CN)

(72) Inventors: Wen Tang, Beijing (CN); Jie Song, Suzhou (CN); Jun Jie Zhang, Jiangsu (CN); Gong Su Ma, Beijing (CN); Can Lin Chen, Jiangsu (CN); Tao Lin, Shanghai (CN); Jian Xin Zhou, Jiangsu (CN); Rong Ju Yang, Beijing (CN)

(73) Assignee: Siemens Aktiengesellschaft, München (DE)

(21) Appl. No.: 17/928,374

(22) PCT Filed: Jun. 1, 2020
(86) PCT No.: PCT/CN2020/093785

§ 371 Date: Nov. 29, 2022

(51) Int. Cl. H04L 45/02; H04L 61/255

(52) U.S. Cl. CPC H04L 45/02; H04L 61/255; H04L 2101/622

(57) ABSTRACT

Various embodiments of the teachings herein include a network topology construction method. The method may include: acquiring a MAC address table of each port on each switch in a target network; determining a first connection relationship in the target network according to the MAC addresses of terminal devices in the target network included in each acquired MAC address table; determining at least one first port according to the first connection relationship in the target network; determining a second connection relationship in the target network according to the MAC addresses included in the MAC address table of each of the first ports in the target network; and determining a network topology of the target network according to the first connection relationship and the second connection relationship in the target network.

### CROSS-REFERENCE TO RELATED APPLICATIONS

This application is a U.S. National Stage Application of International Application No. PCT/CN2020/093785 filed Jun. 1, 2020, which designates the United States of America, the contents of which are hereby incorporated by reference in their entirety.

### TECHNICAL FIELD

The present disclosure relates to the technical field of communications. Various embodiments of the teachings herein include network topology construction methods and/or apparatus.

### BACKGROUND

A network topology refers to the physical layout of various devices interconnected using transmission media. Specifically, the network topology may be a specific physical arrangement of devices or a logical arrangement of devices. A network topology is the basis of network management, and most functions in network management can be realized based on a network topology. With the aid of a network topology, a network administrator can intuitively learn the states of all network devices. Thus the network administrator can be freed from repeated mechanical manual monitoring and locate a fault in the network quickly so that the network is visible, controllable and manageable.

Currently, when a network topology is constructed, physical connection relationships between devices in a network, for example, the connection relationship between terminal devices and switches and the connection relationship between switches, need to be manually identified. Then the network topology is constructed according to the identified physical connection relationships between various devices.

In known network topology construction methods, physical connection relationships between devices in a network are determined through manual identifications, and then a network topology is constructed according to the identified physical connection relationships between various devices. However, since a network possibly comprises a large number of devices and the physical connection relationships between devices in a large network are very complicated, the determination of physical connection relationships between various devices in a network through manual identifications is error prone. As a result, the constructed network topology has a low accuracy.

### SUMMARY

In view of this, the network topology construction method and apparatus, and a computer-readable medium incorporating teachings of the present disclosure can improve the accuracy of the constructed network topology. For example, some embodiments of the teachings herein include a network topology construction method including: acquiring a MAC address table of each port on each switch in a target network, wherein the target network comprises at least two switches and at least one terminal device; determining a first connection relationship in the target network according to the MAC addresses of terminal devices in the target network included in each acquired MAC address table, wherein the first connection relationship is used to represent a connection relationship between terminal devices and switches included in a network; determining at least one first port according to the first connection relationship in the target network, wherein the first port is a port connected with no terminal device on each switch in the target network; determining a second connection relationship in the target network according to the MAC addresses included in the MAC address table of each of the first ports in the target network, wherein the second connection relationship is used to represent a connection relationship between switches in a network; and determining a network topology of the target network according to the first connection relationship and the second connection relationship in the target network.

In some embodiments, determining a first connection relationship in the target network according to the MAC addresses of the terminal devices in the target network that are included in each acquired MAC address table comprises, for each acquired MAC address table, performing the following: if the MAC address table contains only one MAC address of a first terminal device in the target network and no other acquired MAC address tables containing MAC addresses completely the same as the MAC addresses included in the MAC address table exist, determining that the port which the MAC address table belongs to is connected with the first terminal device; if the MAC address table contains at least two MAC addresses of a second terminal device in the target network, determining that the port which the MAC address table belongs to is connected with the second terminal device; determining a first connection relationship in the target network according to the connection relationship between terminal devices and ports on the switches in the target network and the ports included in each switch in the target network.

In some embodiments, determining a second connection relationship in the target network according to the MAC addresses included in the MAC address table of each of the first ports in the target network comprises: determining whether each port on each switch in the target network has a MAC address; if each port on each switch in the target network has a MAC address, determining the second connection relationship in the target network according to the MAC addresses of the ports of the switches included in the MAC address table of each of the first ports in the target network; if at least one port on each switch in the target network has no MAC address, determining the second connection relationship in the target network according to the MAC addresses of terminal devices included in the MAC address table of each of the first ports in the target network.

In some embodiments, determining a second connection relationship in the target network according to the MAC addresses of the ports of the switches included in the MAC address table of each of the first ports in the target network comprises: for any switch in the target network, if the MAC addresses of at least two ports on the switch are in the MAC address table of the same port on another switch in the target network, determining that the switch is a redundancy manager in the target network and deleting the MAC addresses of all ports on the switch from the MAC address table of each first port; for each of the first ports in the target network, if the MAC address table of the first port contains a MAC address of a second port in the target network, determining that the first port is connected with the second port, wherein the first port and the second port are located on different switches in the target network; determining the second connection relationship in the target network according to the connection relationship between each of the first ports and the second port in the target network and the switches the first port and the second port belong to.

In some embodiments, determining a second connection relationship in the target network according to the MAC addresses of terminal devices included in the MAC address table of each of the first ports in the target network comprises: for each of the first ports in the target network, performing the following: screening a third port out of first ports other than the first port in the target network, wherein the MAC address table of the third port and the MAC address table of the first port contain at least one identical MAC address; acquiring a corresponding first MAC address set of the first port, wherein the elements in the first MAC address set are MAC addresses of terminal devices in the MAC address table of the first port; for each of the third ports, acquiring a corresponding second MAC address set of the third port, wherein the elements in the second MAC address set are MAC addresses of terminal devices in the MAC address table of the third port; determining the connection relationship between the first port and the third port according to the inclusion relationship between the first MAC address set and each of the second MAC address sets and the inclusion relationship between the subsets of the first MAC address set and each of the second MAC address sets; and determining the second connection relationship in the target network according to the connection relationship between each of the first ports and the third port in the target network and the switches the first port and the third port belong to.

In some embodiments, acquiring a MAC address table of each port on each switch in a target network comprises acquiring a MAC address table of each port on each switch in the target network from a switch at the convergence layer and/or core layer of the target network, wherein a switch located at the core layer of the target network is connected with a switch located at the convergence layer of the target network, a switch located at the convergence layer of the target network is connected with a switch located at the access layer of the target network, and a switch located at the access layer of the target network is connected with terminal devices.

As another example, some embodiments include a network topology construction apparatus, characterized in that the apparatus comprises: a table acquisition module (21), used to acquire a MAC address table of each port on each switch in a target network, wherein the target network comprises at least two switches and at least one terminal device; a first relationship determination module (22), used to determine a first connection relationship in the target network according to the MAC addresses of terminal devices in the target network that are included in each MAC address table acquired by the table acquisition module (21), wherein the first connection relationship is used to represent a connection relationship between terminal devices and switches in a network; a port screening module (23), used to determine at least one first port according to the first connection relationship determined by the first relationship determination module (22) in the target network, wherein the first port is a port connected with no terminal device on each switch in the target network; a second relationship determination module (24), used to determine a second connection relationship in the target network according to the MAC addresses included in the MAC address table of each of first ports determined by the port screening module (23) in the target network, wherein the second connection relationship is used to represent a connection relationship between switches in a network; and a topology construction module (25), used to determine a network topology of the target network according to the first connection relationship determined by the first relationship determination module (22) and the second connection relationship determined by the second relationship determination module (24) in the target network.

In some embodiments, the first relationship determination module (22) comprises: a first matching unit (221), used for each MAC address table acquired by the table acquisition module (21) to determine that the port which the MAC address table belongs to is connected with a first terminal device if the MAC address table contains only one MAC address of the first terminal device in the target network and no other acquired MAC address tables containing MAC addresses completely the same as the MAC addresses included in the MAC address table exist; a second matching unit (222), used for each MAC address table acquired by the table acquisition module (21) to determine that the port which the MAC address table belongs to is connected with a second terminal device in the target network if the MAC address table contains at least two MAC addresses of the second terminal device; and an integration unit (223), used to determine a first connection relationship in the target network according to the connection relationship determined by the first matching unit (221) and the second matching unit (222) between terminal devices and ports of the switches in the target network and the ports included in each switch in the target network.

In some embodiments, the second relationship determination module (24) comprises: a determination unit (241), used to determine whether each port on each switch in the target network has a MAC address; a first relationship determination unit (242), used to determine the second connection relationship in the target network according to the MAC addresses of the ports of the switches included in the MAC address table of each of the first ports in the target network if the determination unit (241) determines that each port of each switch in the target network has a MAC address; and a second relationship determination unit (243), used to determine the second connection relationship in the target network according to the MAC addresses of terminal devices included in the MAC address table of each of the first ports in the target network if the determination unit (241) determines that at least one port of each switch in the target network has no MAC address.

In some embodiments, the second relationship determination unit (243) comprises: an address deletion subunit (2431), used for any switch in the target network to determine that the switch is a redundancy manager in the target network and delete the MAC addresses of all ports on the switch from the MAC address table of each first port if the MAC addresses of at least two ports on the switch are in the MAC address table of the same port on another switch in the target network; a first relationship determination subunit (2432), used for each of the first ports in the target network to determine that the first port is connected with a second port if the MAC address table of the first port contains a MAC address of the second port in the target network, wherein the first port and the second port are located on different switches in the target network; and a first integration subunit (2433), used to determine the second connection relationship in the target network according to the connection relationship determined by the first relationship determination subunit (2432) between each of the first ports and the second port in the target network and the switches the first port and the second port belong to.

In some embodiments, the second relationship determination unit (243) comprises: a port screening subunit (2434), used for each of the first ports in the target network to screen a third port out of first ports other than the first port in the target network, wherein the MAC address table of the third port and the MAC address table of the first port contain at least one identical MAC address; a first set construction subunit (2435), used for each of first ports in the target network to acquire a corresponding first MAC address set of the first port, wherein the elements in the first MAC address set are MAC addresses of terminal devices in the MAC address table of the first port; a second set construction subunit (2436), used for each of the third ports screened out by the port screening subunit (2434) to acquire a corresponding second MAC address set of the third port, wherein the elements in the second MAC address set are MAC addresses of terminal devices in the MAC address table of the third port; a second relationship determination subunit (2437), used to determine the connection relationship between the first port and the third port according to the inclusion relationship between the first MAC address set acquired by the first set construction subunit (2435) and each of the second MAC address sets acquired by the second set construction subunit (2436) and the inclusion relationship between the subsets of the first MAC address set acquired by the first set construction subunit (2435) and each of the second MAC address sets acquired by the second set construction subunit (2436); and a second integration subunit (2438), used to determine the second connection relationship in the target network according to the connection relationship determined by the second relationship determination subunit (2437) between each of the first ports and the third port in the target network and the switches the first port and the third port belong to.

In some embodiments, the table acquisition module (21) is used to acquire a MAC address table of each port on each switch in the target network from a switch at the convergence layer and/or core layer of the target network, wherein a switch located at the core layer of the target network is connected with a switch located at the convergence layer of the target network, a switch located at the convergence layer of the target network is connected with a switch located at the access layer of the target network, and a switch located at the access layer of the target network is connected with terminal devices.

In some embodiments, the apparatus comprises at least one memory (26) and at least one processor (27), wherein the at least one memory (26) is used to store a machine-readable program, and the at least one processor (27) is used to invoke the machine-readable program to execute the method as described herein.

As another example, some embodiments include a computer-readable medium, characterized in that computer instructions are stored in the computer-readable medium and a processor executes the method as described herein when the computer instructions are executed by the processor.

### BRIEF DESCRIPTION OF THE DRAWINGS

FIG. 1 is a flowchart of a network topology construction method incorporating teachings of the present disclosure;

FIG. 2 shows a network topology incorporating teachings of the present disclosure;

FIG. 3 shows an initialized network topology incorporating teachings of the present disclosure;

FIG. 4 shows a network topology incorporating teachings of the present disclosure after the connection relationship between switches and terminal devices is determined;

FIG. 5 shows a network topology incorporating teachings of the present disclosure after the connection relationship between some switches is determined;

FIG. 6 shows another network topology incorporating teachings of the present disclosure after the connection relationship between some switches is determined;

FIG. 7 shows a network topology incorporating teachings of the present disclosure;

FIG. 8 shows an initialized network topology incorporating teachings of the present disclosure;

FIG. 9 shows a network topology incorporating teachings of the present disclosure after the connection relationship between some switches and terminal devices is determined;

FIG. 10 shows an equivalent network topology incorporating teachings of the present disclosure;

FIG. 11 shows a network topology incorporating teachings of the present disclosure;

FIG. 12 shows an initialized network topology incorporating teachings of the present disclosure;

FIG. 13 shows a network topology incorporating teachings of the present disclosure after the connection relationship between switches and terminal devices is determined;

FIG. 14 is a schematic diagram of a network topology construction apparatus incorporating teachings of the present disclosure;

FIG. 15 is a schematic diagram of a further network topology construction apparatus incorporating teachings of the present disclosure; and

FIG. 16 is a schematic diagram of a network topology construction apparatus comprising a determination unit incorporating teachings of the present disclosure;

FIG. 17 is a schematic diagram of a further network topology construction apparatus comprising a determination unit incorporating teachings of the present disclosure;

FIG. 18 is a schematic diagram of yet a further network topology construction apparatus comprising a determination unit incorporating teachings of the present disclosure; and

FIG. 19 is a schematic diagram of yet a further network topology construction apparatus incorporating teachings of the present disclosure.

### DESCRIPTION OF REFERENCE NUMERALS IN THE DRAWINGS

101: Acquire a MAC address table of each port on each switch in a target network

102: Determine a first connection relationship according to the MAC addresses of terminal devices included in each MAC address table

103: Determine at least one first port according to the first connection relationship in the target network

104: Determine a second connection relationship according to the MAC addresses included in the MAC address table of each of the first ports

105: Determine a network topology of the target network according to the first connection relationship and the second connection relationship in the target network 21: Table 22: First 23: Port screening acquisition module relationship module determination module 24: Second 25: Topology 221: First matching relationship construction module unit determination module 222: Second matching 223: Integration unit 241: Determination unit unit 242: First 243: Second 2431: Address relationship relationship deletion subunit determination unit determination unit 2432: First 2433: First 2434: Port relationship integration subunit screening subunit determination subunit 2435: First set 2436: Second set 2438: Second construction subunit construction subunit integration subunit 2437: Second 26: Memory 27: Processor relationship determination subunit

### DETAILED DESCRIPTION

In some embodiments, a network topology construction method comprises: acquiring a media access control (MAC) address table of each port on each switch in a target network, wherein the target network comprises at least two switches and at least one terminal device; determining a first connection relationship in the target network according to the MAC addresses of terminal devices in the target network in each acquired MAC address table, wherein the first connection relationship is used to represent a connection relationship between terminal devices and switches included in a network; determining at least one first port according to the first connection relationship in the target network, wherein the first port is a port on each switch in the target network that is not connected with a terminal device; determining a second connection relationship in the target network according to the MAC addresses included in the MAC address table of each of the first ports in the target network, wherein the second connection relationship is used to represent a connection relationship between switches in a network; and determining a network topology of the target network according to the first connection relationship and the second connection relationship in the target network.

In some embodiments, a network topology construction apparatus comprises: a table acquisition module, used to acquire a MAC address table of each port on each switch in a target network, wherein the target network comprises at least two switches and at least one terminal device; a first relationship determination module, used to determine a first connection relationship in the target network according to the MAC addresses of terminal devices in the target network that are included in each MAC address table acquired by the table acquisition module, wherein the first connection relationship is used to represent a connection relationship between terminal devices and switches in a network; a port screening module, used to determine at least one first port according to the first connection relationship determined by the first relationship determination module in the target network, wherein the first port is a port connected without a terminal device on each switch in the target network; a second relationship determination module, used to determine a second connection relationship in the target network according to the MAC addresses included in the MAC address table of each of the first ports determined by the port screening module in the target network, wherein the second connection relationship is used to represent a connection relationship between switches in a network; and a topology construction module, used to determine a network topology of the target network according to the first connection relationship determined by the first relationship determination module and the second connection relationship determined by the second relationship determination module in the target network.

In some embodiments, a network topology construction apparatus, comprises at least one memory and at least one processor; the at least one memory is used to store a machine-readable program; and the at least one processor is used to invoke the machine-readable program to execute the method provided in the first aspect.

In some embodiments, a computer-readable medium stores computer instructions, and a processor executes the method provided in the first aspect when the computer instructions are executed by the processor.

In some embodiments, a target network comprises at least two switches and at least one terminal device, after the MAC address table of each port on each switch in the target network is acquired, a first connection relationship representing a connection relationship between terminal devices and switches in the target network can be determined according to the MAC addresses of terminal devices in each of the acquired MAC address table, first ports on each switch that are not connected with a terminal device can be determined according to the first connection relationship, a second connection relationship representing a connection relationship between switches in the target network can be determined according to the MAC addresses included in the MAC address table of each of the first ports, and then the network topology of the target network can be determined according to the first connection relationship and the second connection relationship.

Since the MAC addresses of terminal devices directly or indirectly connected with switch ports are recorded in the MAC address tables of switch ports, the first connection relationship between switches and terminal devices and the second connection relationship between switches in the target network can be derived according to the MAC address tables of ports on each switch in the target network, and then the network topology of the target network can be determined according to the first connection relationship and the second connection relationship. Thus, only the MAC address tables of ports on each switch in the target network need to be acquired and the network topology of the target network can be constructed according to the acquired MAC address tables. In this way, the degree of manual participation in the network topology construction is reduced, an incorrectly constructed network topology caused by an incorrect manual identification of physical connection relationships between devices in a network is avoided, and then the accuracy of the constructed network topology is improved.

In some embodiments, when the first connection relationship is determined according to the MAC addresses of terminal devices that are included in each of the acquired MAC address tables, the connection relationship between terminal devices and switches may be determined according to the number of MAC addresses of terminal devices in the MAC address table. Specifically, the first connection relationship may be determined in the following way: for each acquired MAC address table, if the MAC address table contains only one MAC address of a first terminal device in the target network and no other acquired MAC address tables containing MAC addresses completely the same as the MAC addresses included in the MAC address table exist, determine that the port which the MAC address table belongs to is connected with the first terminal device; if the MAC address table contains at least two MAC addresses of a second terminal device in the target network, determine that the port which the MAC address table belongs to is connected with the second terminal device; determine a first connection relationship in the target network according to the connection relationship between terminal devices and ports of the switches in the target network and the ports included in each switch in the target network.

In some embodiments, if a MAC address table contains only one MAC address of a first terminal device and no other MAC address tables containing MAC addresses completely the same as the MAC addresses in the MAC address table exist, it may be uniquely determined that the switch port which the MAC address table belongs to is connected with the first terminal device. If a MAC address table contains at least two MAC addresses of a second terminal device, it may also be determined that the switch port which the MAC address table belongs to is connected with the second terminal device. For a programmable logic controller (PLC), communication module or host computer supporting PROFIENT, a port usually corresponds to a plurality of MAC addresses, wherein one MAC address is bound to an IP address (the MAC address will appear in the MAC address tables of other switches) and other MAC addresses are used for LLDP/PN-PTCP/MRP communication. Therefore, when the MAC address table of a switch port contains a plurality of MAC addresses corresponding to a terminal device, the connection relationship between the terminal device and the switch port may be determined.

In some embodiments, when the second connection relationship is determined according to the MAC addresses included in the MAC address table of each of the first ports, the second connection relationship may be determined according to whether a port on a switch has a MAC address in different ways. Specifically, the second connection relationship may be determined in the following way: determine whether each port on each switch in the target network has a MAC address; if each port on each switch in the target network has a MAC address, determine the second connection relationship in the target network according to the MAC addresses of the ports of the switches included in the MAC address table of each of the first ports in the target network; if at least one port on each switch in the target network has no MAC address, determine the second connection relationship in the target network according to the MAC addresses of terminal devices in the MAC address table of each of the first ports in the target network.

In some embodiments, the following two cases may exist for a switch: In one case, each port on the switch itself does not have a MAC address (if a management port is provided for the switch, the management port has a MAC address), and in the other case, a MAC address is assigned to each port on the switch. When a switch in a target network is a switch in the first case, the second connection relationship may be determined according to the MAC addresses of terminal devices in the MAC address table of each first port, and when a switch in a target network is a switch in the second case, the second connection relationship may be determined according to the MAC addresses of the ports on switches in the MAC address table of each first port, and of course, the second connection relationship may also be determined according to the MAC addresses of terminal devices in the MAC address table of each first port. If each port on each switch has a MAC address, the MAC addresses of the ports on switches in the MAC address table of the first port may more directly reflect the connection relationship between switches. Thus, the second connection relationship may be determined quickly, and the network topology construction speed may be guaranteed. If not all ports on each switch have a MAC address, the connection relationship between switches may be derived according to the MAC addresses of terminal devices in the MAC address table of the first port. This is a universal way, so, even if each port on each switch has a MAC address, the second connection relationship may also be determined in this way.

In some embodiments, when the second connection relationship is determined according to the MAC addresses of the ports on switches in the MAC address table of each first port, the MAC addresses of ports of a redundancy manager in a target network may be first deleted from the MAC address table of each first port to eliminate interference of the redundancy manager, and then the second connection relationship may be determined according to the MAC addresses of the ports on switches in the MAC address table of each first port.

Specifically, the second connection relationship may be determined in the following way: for any switch in the target network, if the MAC addresses of at least two ports on the switch are in the MAC address table of the same port on another switch in the target network, determine that the switch is a redundancy manager in the target network and delete the MAC addresses of all ports on the switch from the MAC address table of each first port; for each of the first ports in the target network, if the MAC address table of the first port contains a MAC address of a second port in the target network, determine that the first port is connected with the second port, wherein the first port and the second port are located on different switches in the target network; and determine the second connection relationship in the target network according to the connection relationship between each of the first ports and the second port in the target network and the switches the first port and the second port belong to.

In some embodiments, the MAC addresses of at least two ports on a switch serving as a redundancy manager will appear in the MAC address table of the same port on another switch. The switch serving as a redundancy manager may be screened out of the switches according to this feature. After the MAC addresses of each port on the redundancy manager are deleted from the MAC address table of each first port, the MAC addresses of interconnected ports of two switches will appear in each of the respective MAC address tables. Based on this feature, the second connection relationship may be determined according to the MAC addresses of the ports of switches in the MAC address table of each first port. Since the MAC addresses of the ports of switches in each MAC address table may more intuitively reflect the connection relationship between switches, the connection relationship between switches in a target network may be quickly determined according to the MAC addresses of the ports of switches and the network topology construction efficiency may be improved.

In some embodiments, when the second connection relationship is determined according to the MAC addresses of terminal devices in the MAC address table of each first port, the second connection relationship may be determined according to the number of MAC addresses of terminal devices in the MAC address table of each first port and the number of MAC addresses of the same terminal device in the MAC address tables of different first ports.

Specifically, the second connection relationship may be determined in the following way: for each of the first ports in the target network, perform the following: screen a third port out of first ports other than the first port in the target network, wherein the MAC address table of the third port and the MAC address table of the first port contain at least one identical MAC address; acquire a corresponding first MAC address set of the first port, wherein the elements in the first MAC address set are MAC addresses of terminal devices in the MAC address table of the first port; for each of the third ports, acquire a corresponding second MAC address set of the third port, wherein the elements in the second MAC address set are MAC addresses of terminal devices in the MAC address table of the third port; determine the connection relationship between the first port and the third port according to the inclusion relationship between the first MAC address set and each of the second MAC address sets and the inclusion relationship between the subsets of the first MAC address set and each of the second MAC address sets; determine the second connection relationship in the target network according to the connection relationship between each of the first ports and the third port in the target network and the switches the first port and the third port belong to.

In some embodiments, the MAC addresses of terminal devices connected with a lower-layer switch will appear in the MAC address table of a port on an upper-layer switch. Therefore, a set consisting of MAC addresses in the MAC address table of a port on a lower-layer switch is a subset consisting of MAC addresses in a MAC address table of a port on an upper-layer switch. Based on this feature, the second connection relationship may be derived according to the MAC addresses of terminal devices in the MAC address table of each first port. Since different types of switches can acquire a MAC address table containing MAC addresses of terminal devices, the method of determining the second connection relationship is applicable to different types of networks and has high applicability.

In some embodiments, in the case of a MAC address table of each port on each switch in a target network, the MAC address table of each port on each switch in the target network may be acquired from a switch located at the convergence layer and/or core layer of the target network, wherein a switch located at the core layer of the target network is connected with a switch located at the convergence layer of the target network, a switch located at the convergence layer of the target network is connected with a switch located at the access layer of the target network, and a switch located at the access layer of the target network is connected with terminal devices.

In some embodiments, switches in a network may be classified into access layer switches, convergence layer switches and core layer switches. Access layer switches are used to connect terminal devices, convergence layer switches are used to connect access layer switches or terminal devices, and core layer switches are used to connect convergence layer switches or terminal devices. Usually, the number of access layer switches is greater than the number of convergence layer switches, and the number of convergence layer switches is greater than the number of core layer switches. Probes are deployed on convergence layer switches and/or core layer switches, and then the deployed probes are utilized to acquire the MAC address table of a port on a switch from convergence layer switches and/or core layer switches. On the one hand, the number of probes to be deployed to acquire MAC address tables can be reduced, and then the network topology construction efficiency can be improved and the network topology construction cost can be lowered. On the other hand, MAC address tables acquired from convergence layer switches and/or core layer switches can reflect the connection relationship between switches, and thus a complete network topology can be constructed, and the network topology construction solution can be applied to different types of networks.

As mentioned above, currently, when a network topology is constructed, connection relationships between devices in a network, for example, the connection relationship between switches and the connection relationship between switches and terminal devices, need to be manually identified. Then the network topology is constructed according to the identified connection relationships between various devices. When a network comprises a large number of switches and terminal devices, the connection relationship between switches and terminal devices in the network is very complicated. When the connection relationship between devices in the network is incorrectly identified, the constructed network topology will inevitably be incorrect. Therefore, the accuracy of a network topology constructed by the use of the prior method of constructing a network topology through manual identifications of connection relationships between devices in a network is low.

In some embodiments, the MAC address table of a port on a switch contains MAC addresses of terminal devices and the MAC addresses included in the MAC address table can reflect not only the connection relationship between switches and terminal devices, but also the connection relationship between switches. Therefore, the MAC address table of a port on each switch can be acquired from a target network, then the connection relationship between switches and terminal devices and the connection relationship between switches in the target network according to the MAC addresses in each acquired MAC address table can be determined, and then a network topology of the target network according to the connection relationship between switches and terminal devices and the connection relationship between switches can be constructed. Since no manual identification of connection relationships between devices in a network is required during network topology construction, a manual identification error is avoided. Thus, the accuracy of a constructed network topology is improved.

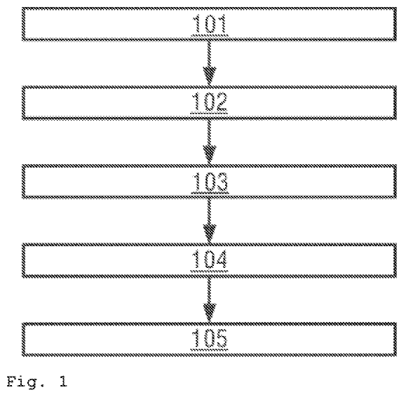

As shown in FIG. 1, embodiments of the present invention provide a network topology construction method and the method comprises the following steps:

Step 101: acquiring a MAC address table of each port on each switch in a target network, wherein the target network comprises at least two switches and at least one terminal device;

Step 102: determining a first connection relationship in the target network according to the MAC addresses of terminal devices in the target network that are included in each acquired MAC address table, wherein the first connection relationship is used to represent a connection relationship between terminal devices and switches in a network;

Step 103: determining at least one first port according to the first connection relationship in the target network, wherein the first port is a port connected with no terminal device on each switch in the target network;

Step 104: determining a second connection relationship in the target network according to the MAC addresses included in the MAC address table of each of the first ports in the target network, wherein the second connection relationship is used to represent a connection relationship between switches in a network;

Step 105: determining a network topology of the target network according to the first connection relationship and the second connection relationship in the target network.

In some embodiments, since the MAC addresses of terminal devices directly or indirectly connected with a switch are recorded in the MAC address table of a switch port, the first connection relationship between switches and terminal devices and the second connection relationship between switches in the target network can be derived according to the acquired MAC address tables after the MAC address table of each port on each switch is acquired from the target network, and then the network topology of the target network can be determined according to the first connection relationship and the second connection relationship. Thus, only the MAC address tables of ports on each switch in the target network need to be acquired and the network topology of the target network can be automatically constructed according to the acquired MAC address tables. In this way, the degree of manual participation in the network topology construction is reduced, an incorrectly constructed network topology caused by an incorrect manual identification of physical connection relationships between devices in a network is avoided, and then the accuracy of the constructed network topology is improved.

In some embodiments, a target network comprises switches and terminal devices, and the terminal devices may be devices having the network communication function, such as hosts, notebook computers, PLCs, communication modules and host computers. In addition, the target network may be an independent network or a part of a network, depending on the requirements for the network topology to be constructed. Therefore, an acquired MAC address table may possibly contain MAC addresses of switches or terminal devices in a network other than the target network. However, the MAC addresses of switches or terminal devices in a network other than the target network have no influence on the implementation of the solution. The MAC addresses of switches or terminal devices in a network other than the target network can be deleted from the acquired MAC address table, or the MAC addresses of switches or terminal devices in a network other than the target network can be used as a reference to construct and validate the network topology.

In some embodiments, when the MAC address table of each port on each switch in the target network is acquired, the MAC address table of each port on each switch can be acquired through the Simple Network Management Protocol (SNMP). Specifically, configuration information complying with the Management Information Base (MIB) framework can be acquired through the SNMP, and then the MAC address table of each port on each switch can be extracted from the acquired configuration information.

In some embodiments, on the basis of the network topology construction method shown in FIG. 1, when the first connection relationship representing the connection relationship between terminal devices and switches in a target network is determined according to the MAC addresses of terminal devices included in each MAC address table, the connection relationship between terminal devices and switches in the target network can be determined based on the following three rules:

(1) When a port on a switch is directly connected with a terminal device (other than a switch), the corresponding MAC address set of a corresponding port in the MAC address table of the switch should contain only one MAC address.

(2) For devices supporting PROFIENT (for example, PLC, communication module or host computer), a port usually corresponds to a plurality of MAC addresses, one MAC address is bound to an IP address (the MAC address will appear in the MAC address tables of other switches) and other MAC addresses are used for LLDP/PN-PTCP/MRP communication. Through the SNMP, the MAC address bound to an IP address can be obtained by accessing ifPhysAddress.1, and the other MAC addresses can be obtained by accessing ifPhysAddress.2/3 . . . .

Therefore, the terminal device connected to a port on a switch can be determined according to whether the MAC address table of the port on the switch contains a plurality of MAC addresses corresponding to the same terminal device.

(3) It can be determined that a terminal device is not directly connected to a port on the first switch by determining whether the MAC address table of the port on the switch contains MAC addresses of the terminal device and MAC addresses of ports on other switches.

In some embodiments, the second connection relationship representing the connection relationship between switches can be determined in two ways according to whether a port on each switch in the target network has a MAC address. When each port on each switch in the target network has a MAC address, the second connection relationship can be determined according to the MAC addresses of the ports on switches in each acquired MAC address table, and when the ports on some switches or all switches in the target network have no MAC addresses, the second connection relationship can be determined according to the MAC addresses of terminal devices in each acquired MAC address table.

Below, embodiment 1 is given to describe in detail the method of determining the second connection relationship according to the MAC addresses of terminal devices in each MAC address table, and embodiment 2 is given to describe in detail the method of determining the second connection relationship according to the MAC addresses of the ports on switches in each MAC address table.

### Embodiment 1

1. Initialization Initialize list_of_mac_set=[] (list of MAC address set);

Initialize switch_to_endpoint=[] (list of (direct) connections between terminal devices and switches);

Initialize switch_to_switch=[] (ports connected between switches);

Initialize the network topology which comprises all n switches S₁ and all terminal devices, with no connection between switches and terminal devices.

2. Preprocess input data and obtain a list_of_mac_set (list of MAC address tables of ports on each switch). Table 1 is a list_of_mac_set (list of MAC address tables).

TABLE 1

| Switch | Port | MAC address set |
|---|---|---|
| S₁ | P₁ | D₁, D₂, D₃, . . . |
| | . . . | |
| | Pₘ | |
| . . . | | |
| Sₙ | P₁ | D₁, D₂, D₃, . . . |
| | . . . | |
| | Pₘ | |

3. For data in list_of_mac_set, identify connections between switches and terminal devices (other than connections between switches) and save the connections in switch_to_endpoint.

1) When a port on a switch is directly connected with an IT device (other than a switch), the corresponding MAC address set of a corresponding port in the MAC address table of the switch should contain only one MAC address.

2) For devices supporting PROFIENT (including PLC, communication module or host computer), a port usually corresponds to a plurality of MAC addresses, one MAC address is bound to an IP address (the MAC address will appear in the MAC address tables of other switches) and other MAC addresses are used for LLDP/PN-PTCP/MRP communication. Through the SNMP, the MAC address bound to an IP address can be obtained by accessing ifPhysAddress.1, and the other MAC addresses can be obtained by accessing ifPhysAddress.2/3 . . . .

Therefore, the terminal device connected to a port on a switch can be determined according to whether the MAC address table of the port on the switch contains a plurality of MAC addresses corresponding to the same device.

3) It can be determined that a terminal device is not directly connected to a port on the first switch by determining whether the MAC address table of the port on the switch contains the MAC address of the terminal device (for example, S623) and MAC addresses of ports on other switches;

connect the identified terminal device to the corresponding switch in the network topology and add S₁={Dⱼ, Dₖ, . . . } (set of terminal devices directly connected to the switch) to switch_to_endpoint.

If a terminal device appears in the MAC address table of a port on a plurality of switches and the MAC address table of the port contains only the MAC address (for example, S₁Pⱼ={Dₖ}) of the terminal device, the switch which the terminal device is connected to cannot be determined temporarily. In this case, let all such MAC address tables of switch ports form an (equivalent) set {S₁Pⱼ={Dₖ}, . . .} and add it to the end of switch_to_endpoint.

4. Extract MAC address sets of ports not connected to terminal devices on each switch from Table 1 and mark them with S₁Pⱼ, wherein S₁ is a switch number and Pⱼ is a port number on a switch. Add S₁P={Dₖ, D₁, . . . } to switch_to_switch.

Two cases exist for a current switch. In one case, each port on the switch has no MAC address (if a management port is provided for the switch, the management port has a MAC address), and in the other case, a MAC address is assigned to each port on the switch. Through the SNMP, the MAC address of each port can be similarly obtained by accessing OIDifPhysAddress (1.3.6.1.2.1.2.2.1.6).1 of the switch. Therefore, the realization of the algorithm requires that those addresses should be filtered out when switch_to_switch is constructed.

5. Derive the connection relationship between switches based on the equivalent relationship.

1) Take (simultaneously delete) a first Sₓ out of switch_to_endpoint.

2) If Sₓ is a set of switches in the form of Sₓ={. . . }, then:

2.1) search switch_to_switch for Sₓ (set of included devices)

2.2) if the unique S_{y}P_{z} (set of included devices) in switch_to_switch is the same as Sₓ, that is to say, S_{y}P_{z}=Sₓ, delete S_{y}P_{z}={D₁, . . . } from switch_to_switch and detect whether the connection between switches Sₓ and S_{y} in the current network topology has been determined,

if the connection relationship has not been determined, go to step 4);

if the connection relationship has been derived, go to step 6);

2.3) if more than two elements are matched in switch_to_switch, that is to say, a plurality of S_{y}P_{z} satisfy ^{S}_{y}ⁱP_{z}=Sₓ, i=1, 2, . . . (multiple equivalent relationships), then check the current network topology, and if the network connections between Sₓ and a plurality of switches S_{y}ⁱ have been derived, directly delete the (multiple) equivalent relationship(s) and go to step 6);

otherwise, the connection relationship between the switch Sₓ and a plurality of switches S_{y}ⁱ cannot be determined currently. Thus, delete each S_{y}ⁱP_{z} from switch_to_switch, generate an equivalence class set {S_{y}¹P_{z}=Sₓ, S_{y}²Pᵥ=Sₓ, . . . }, add it to the end of switch_to_endpoint, and go to step 6);

2.4) If no result is obtained after Sₓ is matched in the complete set, it is necessary to further perform matching in the subset.

Search switch_to_switch for the subset S′⊆Sₓ of Sₓ in the decreasing sequence of the sizes of subsets.

If the unique S_{y}P_{z} (set of included devices) in switch_to_switch is the same as S′, that is to say, S_{y}P_{z}=S′, go to step 2.2) for similar processing.

If more than two elements are matched in switch_to_switch, go to step 2.3) for similar processing.

2.5) If switch_to_switch contains no element corresponding to Sₓ (and the subset), put Sₓ back to the end of switch_to_endpoint and go to step 6).

3) If Sₓ is an equivalence class set in the form of {S_{y}P_{z}={D₁}/S₁, SᵤPᵥ={Dⱼ}/S₁, . . . }, then

3.1) Starting from the first equivalent relationship in the equivalence class set, attempt to check the current equivalent relationship one by one.

3.2) Check the current equivalent relationship, and if the relationship is satisfied in the current network topology, skip the relationship and go back to step 3.1) to select the next equivalent relationship.

3.3) For the current equivalent relationship S_{y}P_{z}={D₁}/S₁, attempt to connect a target device or switch D₁/S₁ to the port P_{z} on the switch S_{y}.

3.4) Check whether the current assumption is reasonable according to list_of_mac_set, including:

whether the port P_{z} on the switch S_{y} has been occupied by other connections so that it cannot be used to connect D₁/S₁, and whether the switch S_{y} also has (or already has had) a port connecting another switch Sᵤ so that such an equivalence class can be formed.

3.5) If the assumptions are unreasonable, go to step 3.1) to attempt to check the next assumption.

3.6) If the current assumption is reasonable, then save the field (including current network topology, switch_to_endpoint, switch_to_switch, current equivalence class set, and selections made currently) selected for the equivalence class.

Delete processed assumed relationships (including skipped and selected assumed relationships) from the equivalence class set. For the remaining equivalence class sets, if they are null, directly go to step 4); if only one relationship exists in an equivalence class set, add the relationship to switch_to_switch, and otherwise, put the modified equivalence class set back at the end of switch_to_endpoint. Then go to step 4).

3.7) If none of equivalent relationships in the equivalence class set hold, put equivalent relationships back at the end of switch_to_endpoint, and continue derivations after more information is obtained from further derivations. Go to step 6).

4) Connect the switch Sₓ to the port P_{z} on the switch S_{y} in the network topology. Determine the port on the switch Sₓ which the port P_{z} on the switch S_{y} is connected to according to the corresponding MAC address set of each port on the switch Sₓ in list_of_mac_set (it is possible that the port cannot be determined).

5) Update the set of devices connected to a switch.

Merge the set of devices connected to the switch Sₓ into S_{y}. If S_{y} already exists in switch_to_endpoint, update S_{y} (=original S_{y}+Sₓ); if switch_to_endpoint does not contain S_{y}, add the merged S_{y} to the end of switch_to_endpoint.

Likewise, merge the set of devices connected to S_{y} into Sₓ, if Sₓ already exists in switch_to_endpoint, update Sₓ (=original Sₓ+S_{y}); if switch_to_endpoint does not contain Sₓ, add the merged Sₓ to the end of switch_to_endpoint.

6) If switches in the current network topology have been connected to form a complete topology, the algorithm ends; otherwise, the algorithm goes back to step 1) to continue performing processing.

If switch_to_endpoint is null and the switches are still not connected to form a complete topology, take the field saved for the latest equivalence class set selection, discard the previous selection, and make an attempt on the reselected equivalent relationship. If a topology cannot be constructed yet, go back to an earlier equivalence class set selection until a complete topology is constructed. Or a complete topology cannot be constructed after attempts are made on all equivalence class sets and the algorithm also ends at this moment.

It should be noted that in the network topology construction method provided by embodiment 1, when at least two terminal devices are connected to an access switch, the algorithm can accurately and completely construct a network topology (embodiment 1) consistent with the actual network connection condition; when only one (or even no) terminal device is connected to an access switch, the algorithm can still derive a complete network topology (embodiment 2), but the network topology, possibly inconsistent with the actual network connection condition, is an equivalent network topology.

### Embodiment 2

1. Initialization Initialize list_of_mac_set=[] (list of MAC address set); initialize the network topology which comprises all n switches S₁ and all terminal devices, with no connection between switches and terminal devices.

2. Preprocess input data (MAC address tables of each port on each switch acquired through the SNMP and the MAC address of the port) and obtain (address table) the MAC address table list_of_mac_set of each port on each switch.

3. Determine the connections between switches and terminal devices according to the MAC address table of each port on each switch:

1) The terminal device connected to a port on a switch can be determined according to whether the MAC address table of the port on the switch contains a plurality of MAC addresses corresponding to the same device.

2) It can be determined that a terminal device is not directly connected to a port on the first switch by determining whether the MAC address table of the port on the switch contains MAC addresses of the terminal device and MAC addresses of ports on other switches.

4. Remove all MAC addresses other than MAC addresses of switch ports from list_of_mac_set, including:

1) MAC addresses of terminal devices;

2) MAC address of the management port of switches;

3) other unrelated MAC addresses.

Then obtain list_of_mac_set only associated with the connections between switches.

5. Derive the connection relationship between switches according to the addresses in the MAC address table of each port on each switch.

In an industrial control network, a ring network consisting of a plurality of switches is often supported so as to realize high reliability of the network. Logically, the network is not a ring (a backup link in the ring is not used for actual communication), but when a point in the network is interrupted, the link for backup will be started to recover the connections between switches. To construct and maintain such a ring network, it is necessary to configure a switch in the ring network as a management node (redundancy manager). The MAC addresses of the ports on the switch will be broadcast to the MAC address tables of different ports on all switches in the ring network. According to this feature, it is very easy to rule out such MAC addresses.

Therefore, the switches in the network are analyzed one by one according to list_of_mac_set generated after step 4:

1) The corresponding MAC address table of each port on the current switch is analyzed. If different ports on the switch all have MAC addresses of (different) ports on the same switch, the switch can be determined to a redundancy manager and the MAC addresses of the ports can be ruled out.

2) For each port whose MAC address table is not null on the current switch (the MAC address table contains only one MAC address in this case), it can be derived that the current port on the current switch is connected to the corresponding port (on another switch) of the MAC address.

The above-mentioned processing is performed repeatedly until all ports on all switches in list_of_mac_set are processed. So far, all switches have been connected to form a complete topology.

The network topology construction method provided by embodiment 1 and embodiment 2 is further described in detail below in combination with specific embodiments. Wherein, embodiments 3, 4 and 5 correspond to embodiment 1, and the second connection relationship is determined according to the MAC addresses of terminal devices in each MAC address table during a network topology construction; embodiment 6 corresponds to embodiment 2, and the second connection relationship is determined according to the MAC addresses of the ports on switches in each MAC address table during a network topology construction.

### Embodiment 3

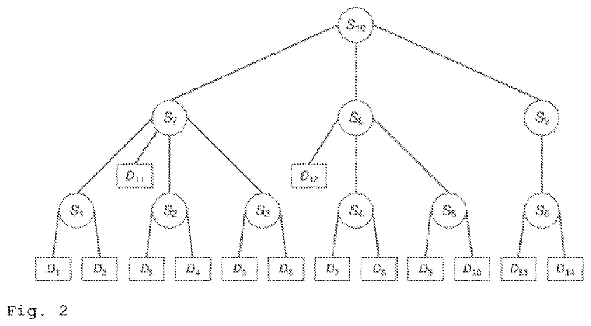

In the present embodiment, the network topology to be monitored is assumed to be what is shown in FIG. 2, wherein a circle represents a switch and a square represents a terminal device.

Supposing that the MAC address table of each switch is obtained in advance through an SNMP detection, then the derivation process of the network topology is as follows:

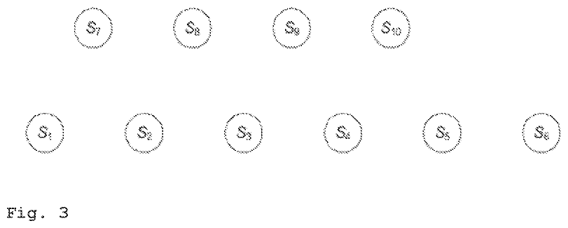

1. Initialize list_of_access_switch=[], switch_to_endpoint=[], and switch_to_switch=[], and initialize the network topology, as shown in FIG. 3.

2. Organize data in the MAC address tables of switch ports obtained through an SNMP detection to obtain list_of_mac_set shown in Table 2.

TABLE 2

| Switch | Port | MAC address set |
|---|---|---|
| S₁ | P₁ | D₁ |
| | P₂ | D₂ |
| | P₃ | D₁₁, D₁₂, D₁₃, D₁₄ |
| S₂ | P₁ | D₃ |
| | P₂ | D₄ |
| | P₃ | D₁₁ |
| S₃ | P₁ | D₅ |
| | P₂ | D₆ |
| | P₃ | D₁₁, D₁₃, D₁₄ |
| S₄ | P₁ | D₇ |
| | P₂ | D₈ |
| | P₃ | D₁₂, D₁₃, D₁₄ |
| S₅ | P₁ | D₉ |
| | P₂ | D₁₀ |
| | P₃ | D₁₁, D₁₂ |
| S₆ | P₁ | D₁₃ |
| | P₂ | D₁₄ |
| | P₃ | D₁, D₂, D₅, D₆, D₇, D₈, D₁₁, D₁₂ |
| S₇ | P₁ | D₁, D₂ |
| | P₂ | D₁₁ |
| | P₃ | D₃, D₄ |
| | P₄ | D₅, D₆ |
| | P₅ | D₁₂, D₁₃, D₁₄ |
| S₈ | P₁ | D₁₂ |
| | P₂ | D₇, D₈ |
| | P₃ | D₉, D₁₀ |
| | P₄ | D₁₁, D₁₃, D₁₄ |
| S₉ | P₁ | D₁₃, D₁₄ |
| | P₂ | D₁, D₂, D₅, D₆, D₇, D₈, D₁₁, D₁₂ |
| S₁₀ | P₁ | D₁, D₂, D₅, D₆, D₁₁ |
| | P₂ | D₇, D₈, D₉, D₁₀, D₁₂ |
| | P₃ | D₁₃, D₁₄ |

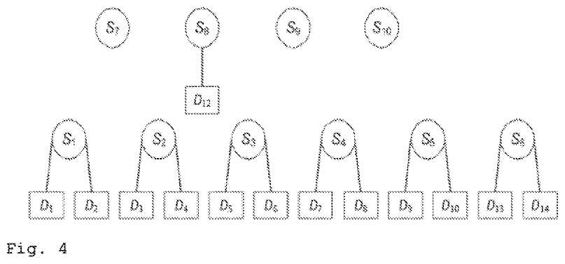

3. Identify the terminal device D₁, i=1 . . . 11, and connect it to the corresponding switch in the network topology, as shown in FIG. 4.

Construct (list of MAC address sets of an access switch) switch_to_endpoint=[S₁={D₁, D₂}, S₂={D₃, D₄}, S₃={D₅, D₆}, S₄={D₇, D₈}, S₅={D₉, D₁₀}, S₆={D₁₃, D₁₄}, S₈={D₁₂}, {S₂P₃={D₁₁}, S₇P₂={D₁₁}}]

4. Construct switch_to_switch (list of MAC address sets between switches) switch_to_switch=[S₁P₃={D₁₁, D₁₂, D₁₃, D₁₄}, S₃P₃={D₁₁, D₁₃, D₁₄}, S₄P₃={D₁₂, D₁₃, D₁₄}, S₅P₃={D₁₁, D₁₂}, S₆P₃={D₁, D₂, D₅, D₆, D₇, D₈, D₁₁, D₁₂}, S₇P₁={D₁, D₂}, S₇P₃={D₃, D₄}, S₇P₄={D₅, D₆}, S₇P₅={D₁₂, D₁₃, D₁₄}, S₈P₂={D₇, D₈}, S₈P₃={D₉, D₁₀}, S₈P₄={D₁₁, D₁₃, D₁₄}, S₉P₁={D₁₃, D₁₄}, S₉P₂={D₁, D₂, D₅, D₆, D₇, D₈, D₁₁, D₁₂}, S₁₀P₁={D₁, D₂, D₅, D₆, D₁₁}, S₁₀P₂={D₇, D₈, D₉, D₁₀, D₁₂}, S₁₀P₃={D₁₃, D₁₄}]

5. Derive the connection relationship between switches based on the equivalent relationship.

(1) Take S₁={D₁, D₂} out of switch_to_endpoint, first search switch_to_switch for elements equivalent to {D₁, D₂} and find a unique S₇P₁={D₁, D₂}, then in the network topology, connect the switch S₁ to the port P₁ on the switch S₇. According to the list_of_mac_set of the ports on the switch S₁, the port P₁ on the switch S₇ can be connected only to the port P₃ on the switch S₁.

Delete S₇P₁={D₁, D₂} from switch_to_switch.

Since switch_to_endpoint originally does not contain S₇, add S₇={D₁, D₂} to the end of switch_to_endpoint.

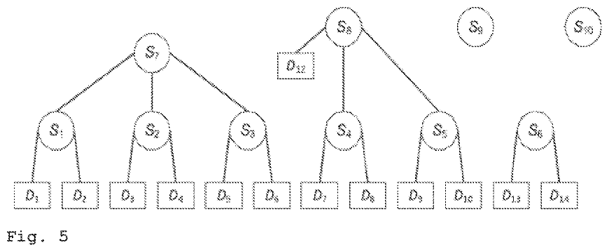

(2) Take S₂={D₃, D₄}, S₃={D₅, D₆}, S₄={D₇, D₈} and S₅={D₉, D₁₀} out of switch_to_endpoint in turn and similarly perform corresponding processing (differently, switch_to_endpoint already contains S₇, and the new device is added to the existing set S₇ at this time) to obtain the network topology shown in FIG. 5.

(3) Take S₆={D₁₃, D₁₄} out of switch_to_endpoint and search switch_to_switch for elements equivalent to {D₁₃, D₁₄}. Two elements S₉P₁={D₁₃, D₁₄} and S₁₀P₃={D₁₃, D₁₄} are matched. At this time, it is impossible to determine whether the switch S₆ is connected to the switch S₉ or the switch S₁₀. Thus, it is necessary to create an equivalence class set {S₉P₁=S₆, S₁₀P₃=S₆} and add it to the end of switch_to_endpoint.

At this time, switch_to_endpoint=[S₈={D₁₂, D₇, D₈, D₉, D₁₀}, {S₂P₃={D₁₁}, S₇P₂={D₁₁}}, S₇={D₁, D₂, D₃, D₄, D₅, D₆}, {S₉P₁=S₆, S₁₀P₃=S₆}]; switch_to_switch=[S₁P₃={D₁₁, D₁₂, D₁₃, D₁₄}, S₃P₃={D₁₁, D₁₃, D₁₄}, S₄P₃={D₁₂, D₁₃, D₁₄}, S₅P₃{D₁₁, D₁₂}, S ₆P₃={D₁, D₂, D₅, D₆, D₇, D₈, D₁₁, D₁₂}, S₇P₅={D₁₂, D₁₃, D₁₄ } S₈P₄={D₁₁, D₁₃, D₁₄}, S₉P₂={D₁, D₂, D₅, D₆, D₇, D₈, D₁₁, D₁₂}, S₁₀P₁={D₁, D₂, D₅, D₆, D₁₁}, S₁₀P₂={D₇, D₈, D₉, D₁₀D₁₂}, S₉P₁{D₁₃, D₁₄}, S₁₀P₃{D₁₃, D₁₄}].

(4) Take S₈={D₁₂, D₇, D₈, D₉, D₁₀} out of switch_to_endpoint and search switch_to_switch for corresponding equivalent elements. Only S₁₀P₂={D₇, D₈, D₉, D₁₀, D₁₂} is matched.

Connect the switch S₈ to the port P₂ on the switch S₁₀ in the network topology.

Delete S₁₀P₂={D₇, D₈, D₉, D₁₀, D₁₂} from switch_to_switch. Since switch_to_endpoint originally does not contain S₇, add S₁₀={D₇, D₈, D₉, D₁₀, D₁₂} to the end of switch_to_endpoint.

(5) Take an equivalence class set {S₂P₃={D₁₁}, S₇P₂={D₁₁}} out of switch_to_endpoint and make inferences in turn.

First assume that D₁₁ is connected to the port P₃ on the switch S₂. From the previous inference, it can be learned that the port is already used for connecting the switch S₇ and thus the assumption is infeasible.

Then assume that D₁₁ is connected to the port P₂ on the switch S₇. Since it has been inferred that the port P₃ on the switch S₂ is connected to the port P₃ on the switch S₇, it is natural to obtain S₂P₃={D₁₁}. Therefore, the assumption holds.

Based on the above-mentioned derivation, connect the device D₁₁ to the port P₂ on the switch S₇ in the network topology, and add D₁₁ to S₇ in switch_to_endpoint.

(6) Take S₇={D₁, D₂, D₃, D₄, D₅, D₆, D₁₁} out of switch_to_endpoint and search switch_to_switch for corresponding equivalent elements. No element is matched.

Further, search switch_to_switch for the subsets of S₇ (in a decreasing sequence of the sizes of the subsets). Only S₁₀P₁={D₁, D₂, D₅, D₆, D₁₁} can be matched.

Connect the switch S₇ to the port P₁ on the switch S₁₀ in the network topology.

Delete S₁₀P₁={D₁, D₂, D₅, D₆, D₁₁} from switch_to_switch.

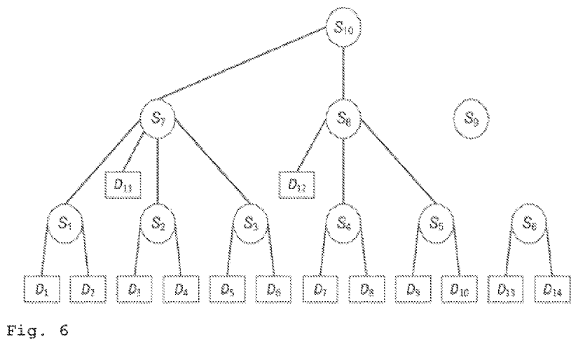

Add {D₁, D₂, D₅, D₆, D₁₁} to the set S₁₀ in switch_to_endpoint. Now, the network topology is shown in FIG. 6.

(7) Take an equivalent relationship {S₉P₁=S₆, S₁₀P₃=S₆} out of switch_to_endpoint and make inferences in turn.

First assume that the switch S₆ is connected to the port P₃ on the switch S₁₀. Then, the equivalent relationship {S₉P₁=S₆, S₁₀P₃=S₆} possibly appears only when the switch S₉ is still connected to the switch S₁₀. However, the switch S₁₀ has three network ports in total according to list_of_mac_set, one is connected to the switch S₇, one is connected to the switch S₈, and it is impossible that the remaining port is simultaneously connected to the switch S₆ and the switch S₉. Therefore, the assumption does not hold.

Assume that the switch S₆ is connected to the port P₁ on the switch S₉. No evidence shows that the assumption is contradictory.

Based on the above-mentioned derivation, connect the device D₆ to the port P₁ on the switch S₉ in the network topology, and add S₉={D₁₃, D₁₄} to the end of switch_to_endpoint.

(8) Take S₁₀={D₁, D₂, D₅, D₆, D₁₁, D₇, D₈, D₉, D₁₀, D₁₂} out of switch_to_endpoint and search switch_to_switch for corresponding equivalent elements. No element is matched.

Further, search switch_to_switch for subsets of S₁₀ (in a decreasing sequence of sizes of the subsets). Wherein, the subset {D₁, D₂, D₅, D₆, D₇, D₈, D₁₁, D₁₂} can match two elements: S₆P₃={D₁, D₂, D₅, D₆, D₇, D₈, D₁₁, D₁₂} and S₉P₂={D₁, D₂, D₅, D₆, D₇, D₈, D₁₁, D₁₂}.

An analysis shows that the two sets reflect the connection relationship between S₉ and S₆, obtained in step 7. Thus, delete S₆P₃={D₁, D₂, D₅, D₆, D₇, D₈, D₁₁, D₁₂} and S₉P₂={D₁, D₂, D₅, D₆, D₇, D₈, D₁₁, D₁₂} from switch_to_switch.

(9) Take S₉={D₁₃, D₁₄} out of switch_to_endpoint and search switch_to_switch for elements equivalent to {D₁₃, D₁₄}. Two elements S₉P₁={D₁₃, D₁₄} and S₁₀P₃={D₁₃, D₁₄} are matched (again). Wherein, S₉P₁={D₁₃, D₁₄}, a reflection of the current S₉={D₁₃, D₁₄}, is skipped. Thus, connect the switch S₉ to the port P₃ on the switch S₁₀ in the network topology, and delete S₉P₁={D₁₃, D₁₄} and S₁₀P₃={D₁₃, D₁₄} from switch_to_switch.

At this time, switch_to_endpoint is null and all switches are mutually connected (to form an arbitrary reachable topology). The algorithm ends. It can be seen that the algorithm accurately derives the original network topology.

### Embodiment 4

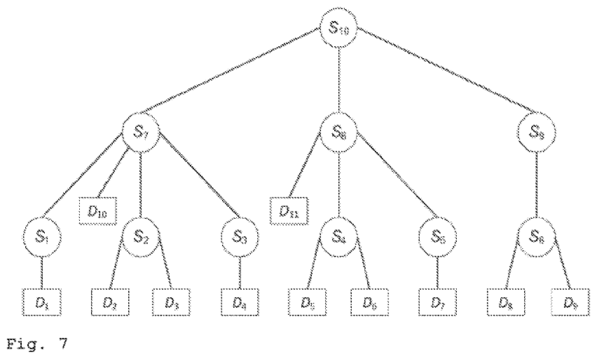

In the present embodiment, the network topology to be monitored is assumed to be what is shown in FIG. 7, wherein a circle represents a switch and a square represents a terminal device.

Since the MAC address table of a port on a switch is associated with whether communication exists between devices, the following assumptions are made in the present embodiment:

D1 to D4 communicate with only D10,

D5 to D7 communicate with only D11,

and D8, D9, D10 and D11 communicate with each other.

Supposing that the MAC address table of each switch is obtained through an SNMP detection, then the derivation process of the network topology is as follows:

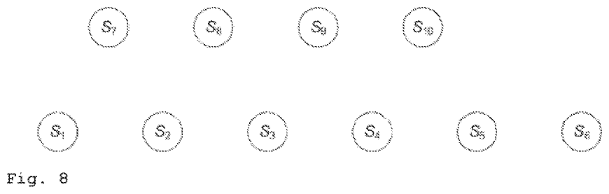

1. Initialize list_of_mac_set=[], switch_to_endpoint=[], and switch_to_switch=[], and initialize the network topology, as shown in FIG. 8.

2. Organize data in the MAC address tables of switch ports obtained through an SNMP detection to obtain list_of_mac_set shown in Table 3.

TABLE 3

| Switch | Port | MACaddressset |
|---|---|---|
| S₁ | P₁ | D₁ |
| | P₂ | D₂ |
| | P₃ | D₁₀ |
| S₂ | P₁ | D₂ |
| | P₂ | D₃ |
| | P₃ | D₁₀ |
| S₃ | P₁ | D₄ |
| | P₂ | D₁₀ |
| S₄ | P₁ | D₅ |
| | P₂ | D₆ |
| | P₃ | D₁₁ |
| S₅ | P₁ | D₇ |
| | P₂ | D₁₁ |
| S₆ | P₁ | D₈ |
| | P₂ | D₉ |
| | P₃ | D₁₀, D₁₁ |
| S₇ | P₁ | D₁ |
| | P₂ | D₁₀ |
| | P₃ | D₂, D₃ |
| | P₄ | D₄ |
| | P₅ | D₈, D₉, D₁₁ |
| S₈ | P₁ | D₁₁ |
| | P₂ | D₅, D₆ |
| | P₃ | D₇ |
| | P₄ | D₈, D₉, D₁₀ |
| S₉ | P₁ | D₈, D₉ |
| | P₂ | D₁₀, D₁₁ |
| S₁₀ | P₁ | D₁₀ |
| | P₂ | D₁₁ |
| | P₃ | D₈, D₉ |

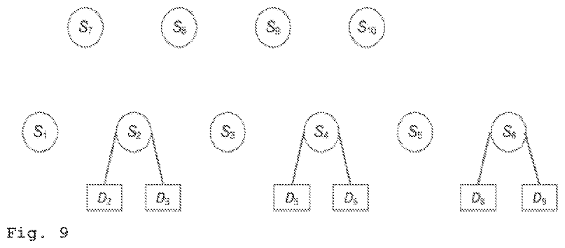

3. Identify the terminal device D₁, i=1 . . . 11, and connect it to the corresponding switch in the network topology, as shown in FIG. 9.

Construct a list of MAC address sets of the access switch: switch_to_endpoint=[S₂={D₂, D₃}, S₄={D₅, D₆}, S₆={D₈, D₉}, {S₇P₁={D₁}, S₁P₁={D₁}}, {S₁P₂={D₁₀}, S₂P₃={D₁₀}, S₃P₂={D₁₀}, S₇P₂={D₁₀}, S₁₀P₁={D₁₀}, {S₃P₁={D₄}, S₇P₄=}}, {S₅P₁={D₇}, S₈P₃={D₇}}, {S₄P₃={D₁₁}, S₅P₂={D₁₁}, S₈P₁={D₁₁}, S₁₀P₂={D₁₁}].

Since other devices, for example, D₁ and DL₄, simultaneously appear on ports of a plurality of switches, it is temporarily impossible to determine the switches which they are directly connected to.

4. Construct switch_to_switch (list of MAC address sets between switches) as follows:

switch_to_switch=[S₆P₃={D₁₀, D₁₁}, S₇P₃={D₂, D₃} S ₈P₂={D₅, D₆}, S₈P₄={D₈, D₉, D₁₀}, S₉P₁={D₈, D₉}, S₉P₂={D₁₀, D₁₁}, S₁₀P₃={D₈, D₉}].

5. Derive the connection relationship between switches based on the equivalent relationship.

(1) Take S₂={D₂, D₃} out of switch_to_endpoint, first search switch_to_switch for elements equivalent to {D₁, D₂} and find a unique S₇P₃={D₂, D₃}, then in the network topology, connect the switch S₂ to the port P₃ on the switch S₇. According to the list_of_mac_set of the ports on the switch S₂, the port P₃ on the switch S₇ can be connected only to the port P₃ on the switch S₂.

Delete S₇P₁={D₁, D₂} from switch_to_switch. Since switch_to_endpoint originally does not contain S₇, add S₇={D₂, D₃} to the end of switch_to_endpoint.

(2) Take S₄={D₅, D₆} out of switch_to_endpoint, first search switch_to_switch for elements equivalent to {D₅, D₆} and find a unique S₈P₂={D₅, D₆}, then in the network topology, connect the switch S₄ to the port P₂ on the switch S₈. According to the list_of_mac_set of the ports on the switch S₄, the port P₂ on the switch S₈ can be connected only to the port P₃ on the switch S₄.

Delete S₈P₂={D₅, D₆} from switch_to_switch.

Since switch_to_endpoint originally does not contain S₈, add S₈={D₅, D₆} to the end of switch_to_endpoint.

(3) Take S₆={D₈, D₉} out of switch_to_endpoint and search switch_to_switch for elements equivalent to {D₈, D₉}. Two elements S₉P₁={D₈, D₉} and S₁₀P₃={D₈, D₉} are matched. At this time, it is impossible to determine whether the switch S₆ is connected to the switch S₉ or the switch S₁₀. Thus, it is necessary to create an equivalence class set {S₉P₁=S₆, S₁₀P₃=S₆} and add it to the end of switch_to_endpoint. Meanwhile, delete S₉P₁={D₈, D₉} and S₁₀P₃={D₈, D₉} from switch_to_switch.

(4) Take an equivalence class set {S₇P₁={D₁}, S₁P₁={D₁}} out of switch_to_endpoint and make inferences in turn.

First assume that D₁ is connected to the port P₁ on the switch S₇. According to list_of_mac_set, the assumption currently may hold. Thus, save the existing selected field.

Based on the above-mentioned derivation, save the remaining S₁P₁={D₁} in the equivalence class set into switch_to_switch.

Connect the device D₁ to the port P₁ on the switch S₇ in the network topology.

Add D₁ to S₇ in switch_to_endpoint.

(5) Take an equivalence class set {S₁P₂={D₁₀}, S₂P₃={D₁₀}, S₃P₂={D₁₀} S₇P₂={D₁₀}, S₁₀P₁={D₁₀}} out of switch_to_endpoint and make inferences in turn.

First assume that D₁₀ is connected to the port P₂ on the switch S₁. According to list_of_mac_set, the assumption currently may hold.

Then, save the existing selected field.

Based on the above-mentioned derivation, add the remaining {S₂P₃={D₁₀}, S₃P₂={D₁₀}, S₇P₂={D₁₀}, S₁₀P₁={D₁₀}} in the equivalence class set to the end of switch_to_endpoint.

Connect the device D₁₀ to the port P₂ on the switch S₁ in the network topology.

Since switch_to_endpoint originally does not contain S₁, add S₁={D₁₀} to the end of switch_to_endpoint.

(6) Take an equivalent relationship {S₃P₁={D₄}, S₇P₄={D₄}} out of switch_to_endpoint and make inferences in turn.

First assume that D₄ is connected to the port P₁ on the switch S₃. According to list_of_mac_set, the assumption currently may hold. Thus, save the existing selected field.

Based on the above-mentioned derivation, save the remaining S₇P₄={D₄} in the equivalence class set into switch_to_switch.

Connect the device D₄ to the port P₁ on the switch S₃ in the network topology.

Since switch_to_endpoint originally does not contain S₃, add S₃={D₄} to the end of switch_to_endpoint.

(7) Take an equivalent relationship {S₅P₁={D₇}, S₈P₃={D₇}} out of switch_to_endpoint and make inferences in turn.

First assume that D₇ is connected to the port P₁ on the switch S₅. According to list_of_mac_set, the assumption currently may hold. Thus, save the existing selected field.

Based on the above-mentioned derivation, save the remaining S₈P₃={D₇} in the equivalence class set into switch_to_switch.

Connect the device D₇ to the port P₁ on the switch S₅ in the network topology.

Since switch_to_endpoint originally does not contain S₅, add S₅={D₇} to the end of switch_to_endpoint.

(8) Take an equivalent relationship {S₄P₃={D₁₁}, S₅P₂={D₁₁}, S₈P₁={D₁₁}, S₁₀P₂={D₁₁}} out of switch_to_endpoint and make inferences in turn.

First assume that D₁₁ is connected to the port P₃ on the switch S₄. According to list_of_mac_set, it can be determined that the port P₃ on the switch S₄ is already connected to the switch S₈, and therefore, the assumption does not hold.

Then assume that D₁₁ is connected to the port P₂ on the switch S₅. According to list_of_mac_set, it can be determined that S₅ has only two related ports and P₁ is connected to D₇. If P₂ is connected to (another terminal device) D₁₁, the switch has no network port to connect other switches. Thus, the current equivalence class set is formed. Therefore, the assumption does not hold, either.

Then assume that D₁₁ is connected to the port P₁ on the switch S₈. According to list_of_mac_set, the assumption holds. Thus, save the existing selected field.

Based on the above-mentioned derivation, add the remaining {S₄P₃={D₁₁}, S₅P₂={D₁₁}, S₁₀P₂={D₁₁}} in the equivalence class set to the end of switch_to_endpoint. Connect the device D₁₁ to the port P₁ on the switch S₈ in the network topology.

Merge S₈={D₁₁} into S₁ in switch_to_endpoint.

(9) Take S₇={D₂, D₃, D₁} out of switch_to_endpoint and search switch_to_switch for elements equivalent to {D₂, D₃, D₁}. No element is found.

Thus, construct the subset of {D₂, D₃, D₁} in a decreasing sequence of the sizes of subsets and search switch_to_switch for the corresponding subset. Finally, a unique S₁P₁={D₁} is found according to {D₁}. Then, in the network topology, connect the switch S₇ to the port P₁ on the switch S₁. According to the list_of_mac_set of the ports on the switch S₇, the port P₁ on the switch S₁ can be connected only to the port P₂ on the switch S₇.

Since S₁={D₁₀}, it is natural to expand S₇={D₂, D₃, D₁, D₁₀}. Add it to the end of switch_to_endpoint.

Delete S₁P₁={D₁} from switch_to_switch.

Merge D₁ into S₁ in switch_to_endpoint.

(10) Take S₈={D₅, D₆, D₁₁} out of switch_to_endpoint and search switch_to_switch for elements equivalent to {D₅, D₆, D₁₁} and the subsets thereof. No element is found. Thus, put S₈={D₅, D₆, D₁₁} back to the end of switch_to_endpoint.

(11) Take an equivalent relationship {S₉P₁=S₆, S₁₀P₃=S₆} out of switch_to_endpoint and make inferences in turn.

First assume that S₆ is connected to the port P₁ on the switch S₉. According to list_of_mac_set, the assumption holds. Thus, save the existing selected field.

Based on the above-mentioned derivation, save the remaining S₁₀P₃={D₈, D₉} in the equivalence class set into switch_to_switch.

Connect the switch S₆ to the port P₁ on the switch S₉ in the network topology.

Add S₉={D₈, D₉} to the end of switch_to_endpoint.

(12) Take an equivalent relationship {S₂P₃={D₁₀}, S₃P₂={D₁₀}, S₇P₂={D₁₀}, S₁₀P₁={D₁₀}} out of switch_to_endpoint and make inferences in turn.

Since it has been inferred that D₁₀ is connected to the switch S₁, the switch S₁ is connected to the switch S₇ and the switch S₇ is connected to the switch S₂ in the existing network topology, S₂P₃={D₁₀} is satisfied and can be skipped.

For S₃P₂={D₁₀}, first assume that the device is directly connected to the switch S₁. According to list_of_mac_set, the assumption does not hold. Then assume that the device is connected to the switch S₇. According to the available information, the assumption holds. According to list_of_mac_set, it can also be derived that the switch S₃ is connected to the port P₄ on the switch S₇.

Based on the above-mentioned derivation, save the remaining S₁₀P₁={D₁₀} in the equivalence class set into switch_to_switch and delete S₇P₄={D₄} from switch_to_switch. Connect the switch S₃ to the port P₄ on the switch S₇ in the network topology.

Add S₃={D₄, D₁₀} and S₃={D₄} to the end of switch_to_endpoint.

(13) Take S₁={D₁₀, D₁} out of switch_to_endpoint and search switch_to_switch for elements equivalent to {D₁₀, D₁} and the subsets thereof. No element is found. Thus, put S₁={D₁₀, D₁} back to the end of switch_to_endpoint.

(14) Take an equivalent relationship {S₄P₃={D₁₁}, S₅P₂={D₁₁}, S₁₀P₂={D₁₁}} out of switch_to_endpoint and make inferences in turn.

Since it has been inferred that D₁₁ is connected to the switch S₈ and the switch S₄ is connected to the switch S₈ according to the existing network topology, S₄P₃={D₁₁} is satisfied and can be skipped.

For S₅P₂={D₁₁}, first assume that the device is directly connected to the switch S₈. According to list_of_mac_set, the assumption holds. According to list_of_mac_set, it can also be derived that the switch S₅ is connected to the port P₃ on the switch S₈.

Based on the above-mentioned derivation, save the remaining S₁₀P₂={D₁₁} in the equivalence class set into switch_to_switch.

Connect the switch S₅ to the port P₃ on the switch S₈ in the network topology.

Add S₅={D₇, D₁₁} and S₈={D₇} to switch_to_endpoint.

(15) Take an equivalent relationship {S₄P₃={D₁₁}, S₅P₂={D₁₁}, S₁₀P₂={D₁₁}} out of switch_to_endpoint and make inferences in turn.

Since it has been inferred that D₁₁ is connected to the switch S₈ and the switch S₄ is connected to the switch S₈ according to the existing network topology, S₄P₃={D₁₁} is satisfied and can be skipped.

Similarly, S₅ is connected to S₈ according to the existing network topology. Thus, S₅P₂={D₁₁} is satisfied and can be skipped.

For S₁₀P₂={D₁₁}, first assume that the device is directly connected to the switch S₈. According to list_of_mac_set, the assumption holds. According to list_of_mac_set, it can also be derived that the switch S₁₀ is connected to the port P₄ on the switch S₈.

Based on the above-mentioned derivation, connect the device S₁₀P₂ to the port P₄ on the switch S₈ in the network topology.

Add S₁₀={D₅, D₆, D₁₁, D₇} to switch_to_endpoint.

(16) Take S₇={D₂, D₃, D₁, D₄, D₁₀} out of switch_to_endpoint and search switch_to_switch for elements equivalent to {D₂, D₃, D₁, D₄, D₁₀}. No element is found.

Thus, construct the subset of {D₂, D₃, D₁, D₄, D₁₀} in a decreasing sequence of the sizes of subsets and search switch_to_switch for the corresponding subset. Finally, a unique S₁₀P₂={D₁₁} is found according to {D₁₁}. Then, in the network topology, connect the switch S₇ to the port P₁ on the switch S₁₀. According to the list_of_mac_set of the ports on the switch S₇, the port P₁ on the switch S₁₀ can be connected only to the port P₄ on the switch S₇.

Thus, S₁₀={D₂, D₃, D₁, D₄, D₁₀} can be expanded into switch_to_endpoint.

Delete S₁₀P₂={D₁₁} from switch_to_switch.

Merge D₁ into S₁ in switch_to_endpoint.

(17) Take S₈={D₅, D₆, D₁₁, D₇} out of switch_to_endpoint and search switch_to_switch for elements equivalent to {D₅, D₆, D₁₁, D₇}. No element is found.

Thus, construct the subset of {D₅, D₆, D₁₁, D₇} in a decreasing sequence of the sizes of subsets and search switch_to_switch for the corresponding subset. Finally, a unique S₈P₃={D₇} is found according to {D₁₁}. Then, in the network topology, the switch S₈ is already connected to the switch S₁₀ and thus can be skipped.

(18) Take S₉={D₈, D₉} out of switch_to_endpoint and search switch_to_switch for elements equivalent to {D₈, D₉}. The unique S₁₀P₃={D₈, D₉} is matched. Then, connect the switch S₉ to the port P₃ on the switch S₁₀ in the network topology.

In addition, according to the ports of S₉ (according to list_of_mac_set), the port P₁ of S₁₉₀ can be connected only to the port P₃ of the switch S₁₀.

Thus, S₁₀={D₈, D₉} can be expanded into switch_to_endpoint.

Delete S₁₀P₃={D₈, D₉} from switch_to_switch.

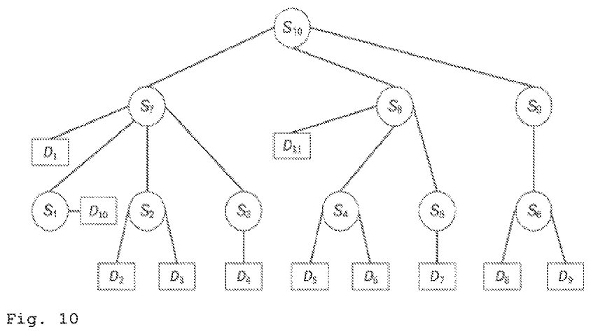

So far, all switches have been connected to form an integral body. The algorithm ends. The obtained network topology is shown in FIG. 10.

This topology is equivalent to the original topology. The only difference is that the switches which D₁ and D₁₀ are connected to are different. It is very easy to manually adjust the difference to obtain an accurate original topology.

### Embodiment 5

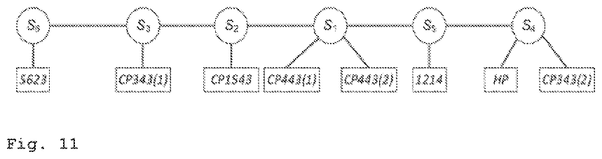

The network adopted in the present embodiment is a common operational technology (OT) network consisting of a plurality of switches. FIG. 11 shows the network topology, wherein a circle represents a switch and a square represents a terminal device.

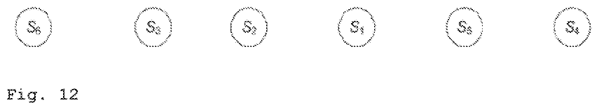

1. Initialize list_of_mac_set=[], switch_to_endpoint=[], and switch_to_switch=[], and initialize the network topology, as shown in FIG. 12.

2. Organize data in the MAC address tables of switch ports obtained through an SNMP detection to obtain list_of_mac_set shown in Table 4, and map it into symbols of corresponding devices (obtained through the SNMP detection).

In the present embodiment, the ports on each switch and the management port on the switch have their own MAC addresses, and the MAC addresses also appear in the MAC address table of each port on each switch. The MAC address in the form of “XX-XX-XX-XX-XX-XX SmPn” represents the MAC address of the port n on the switch m.

TABLE 4

| Switch. | Port | MAC address set | |
|---|---|---|---|
| S₁ | P₁ | 00-1B-1B-87-4A-81 | S623 |
| | | 00-1B-1B-91-6B-DE | S4P2 |
| | | 00-1B-1B-91-6C-01 | S2P2 |
| | P₂ | 00-1B-1B-91-6B-DD | S4P1 |
| | | 00-1B-1B-91-6B-FB | S5P1 |
| | | 00-1C-06-1D-41-88 | 1214 |
| | | 08-00-06-01-00-00 | |
| | | EC-8E-B5-92-CB-75 | HP |
| | P₃ | 00-1B-1B-91-95-C2 | CP443(1) |
| | | 00-1B-1B-91-95-C5 | |
| | P₄ | 00-1B-1B-91-97-1E | CP443(2) |
| | | 00-1B-1B-91-97-21 | |
| S₂ | P₁ | 00-1B-1B-87-4A-81 | S623 |
| | | 00-1B-1B-91-6B-DE | S4P2 |
| | | 00-1B-1B-91-6B-ED | S3P2 |
| | P₂ | 00-1B-1B-91-6B-DD | S4P1 |
| | | 00-1B-1B-91-6B-E7 | S1P1 |
| | | 00-1B-1B-91-95-C2 | CP443(1) |
| | | 00-1B-1B-91-97-1E | CP443(2) |
| | | 00-1C-06-1D-41-88 | 1214 |
| | | 08-00-06-01-00-00 | |
| | | EC-8E-B5-92-CB-75 | HP |
| | P₃ | | |
| | P₄ | 00-1B-1B-8A-A2-6B | CP1543 |
| S₃ | P₁ | 00-1B-1B-87-4A-81 | S623 |
| | | 00-1B-1B-91-6B-DE | S4P2 |
| | | 00-1B-1B-91-6B-E3 | S5P2 |
| | P₂ | 00-1B-1B-8A-A2-6B | CP1543 |
| | | 00-1B-1B-91-6B-DD | S4P1 |
| | | 00-1B-1B-91-6C-00 | S2P1 |
| | | 00-1B-1B-91-95-C2 | CP443(1) |
| | | 00-1B-1B-91-97-1E | CP443(2) |
| | | 00-1C-06-1D-41-88 | 1214 |
| | | 08-00-06-01-00-00 | |
| | | EC-8E-B5-92-CB-75 | HP |
| | P₃ | | |
| | P₄ | 00-1B-1B-90-56-49 | CP343(1) |
| | | 00-1B-1B-90-56-4A | |
| S₄ | P₁ | 00-1B-1B-87-4A-81 | S623 |
| | | 00-1B-1B-91-6B-E6 | S1 |
| | | 00-1B-1B-91-6B-EB | S3 |
| | | 00-1B-1B-91-6B-FC | S5P2 |
| | | 00-1B-1B-91-6B-FF | S2 |
| | P₂ | | |
| | P₃ | EC-8E-B5-92-CB-75 | HP |
| | P₄ | 00-1B-1B-C5-2E-D2 | CP343(2) |
| | | 08-00-06-01-00-00 | |
| S₅ | P₁ | 00-1B-1B-87-4A-81 | S623 |
| | | 00-1B-1B-91-6B-DE | S4P2 |
| | | 00-1B-1B-91-6B-E6 | S1 |
| | | 00-1B-1B-91-6B-E8 | S1P2 |
| | | 00-1B-1B-91-6B-EB | S3 |
| | | 00-1B-1B-91-6B-FF | S2 |
| | P₂ | 00-1B-1B-91-6B-DD | S4P1 |
| | | 08-00-06-01-00-00 | |
| | | EC-8E-B5-92-CB-75 | HP |
| | P₃ | | |
| | P₄ | 00-1C-06-1D-41-88 | 1214 |
| | | 00-1C-06-1D-41-89 | |
| S₆ | P₁ | 00-1B-1B-91-6B-DE | S4P2 |
| | P₂ | 00-1B-1B-8A-A2-6B | CP1543 |
| | | 00-1B-1B-90-56-49 | CP343(1) |
| | | 00-1B-1B-91-6B-DD | S4P1 |
| | | 00-1B-1B-91-6B-EC | S3P1 |
| | | 00-1B-1B-91-95-C2 | CP443(1) |
| | | 00-1B-1B-91-97-1E | CP443(2) |
| | | 00-1C-06-1D-41-88 | 1214 |
| | | 08-00-06-01-00-00 | |
| | | EC-8E-B5-92-CB-75 | HP |
| | P₃ | 00-1B-1B-87-4A-81 | S623 |
| | P₄ | | |

The algorithm commonly utilizes terminal devices in the MAC address tables of switches for analyses, instead of utilizing the MAC addresses of ports on switches to derive the connection relationship between switches. However, port information of switches can help to determine whether a terminal device is directly connected to a switch. For example, although the switch S623 appears on a port on each switch, only the port S₆P₃ has the MAC address of the switch S623 and the other ports on which the switch S623 appears also have MAC addresses of other ports. Thus, it can be inferred that the switch S623 is directly connected to the port S₆P₃.

The list_of_mac_set obtained after the MAC address of the switch is removed (again) is shown in Table 5.

TABLE 5

| Switch | Port | MAC address set |
|---|---|---|
| S₁ | P₁ | S623 |
| | P₂ | 1214, HP |
| | P₃ | CP443(1)* |
| | P₄ | CP443(2)* |
| S₂ | P₁ | S623 |
| | P₂ | CP443(1), CP443(2), 1214, HP |
| | P₃ | |
| | P₄ | CP1543 |
| S₃ | P₁ | S623 |
| | P₂ | CP1543, CP443(1), CP443(2), 1214, HP |
| | P₃ | |
| | P₄ | CP343(1)* |
| S₄ | P₁ | S623 |
| | P₂ | |
| | P₃ | HP* |
| | P₄ | CP343(2)* |
| S₅ | P₁ | S623 |
| | P₂ | HP |
| | P₃ | |
| | P₄ | 1214* |
| S₆ | P₁ | |
| | P₂ | CP1543, CP343(1), CP443(1), CP443(2), 1214, HP |
| | P₃ | S623* |
| | P₄ | |

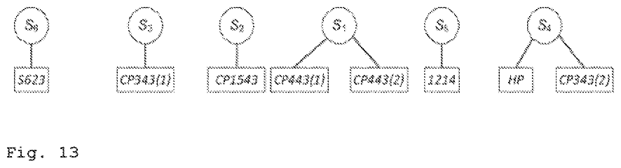

3. Identify the terminal device D₁, i=1 . . . 11, and connect it to the corresponding switch in the network topology, as shown in FIG. 13.

Construct a list of MAC address sets of the access switch:

switch_to_endpoint=[S₁={CP443(1), CP443(2)}, S₂={CP1543}, S₃={CP343(1)}, S₄={HP, CP343(2)}, S₅={1214}, S₆={S623}].

4. Construct switch_to_switch list of MAC address sets between switches as follows:

switch_to_switch=[S₁P₁={S623}, S₁P₂={1214, HP}, S₂P₁={S623}, S₂P₂={CP44 3(1), CP443(2), 1214, Hp}, S₃P₁={S623}, S₃P₂={CP1543, CP443(1), CP443(2), 1214,HP}, S₄P₁={S623}, S₅P₁={S623}, S₅P₂={HP}, S₆P₂={CP1543, CP343 (1), CP 443 (1), CP443 (2), 1214, HP}].

5. Derive the connection relationship between switches based on the equivalent relationship.

(1) Take S₁={CP443(1),CP443(2)} out of switch_to_endpoint and search switch_to_switch for elements equivalent to {CP443(1),CP443(2)} and the subsets thereof. No element is found. Thus, put S₁={CP443(1),CP443(2)} back to the end of switch_to_endpoint.

(2) Take S₂={CP1543} out of switch_to_endpoint and search switch_to_switch for elements equivalent to {CP1543}. No element is found. Thus, put S₂={CP1543} back to the end of switch_to_endpoint.

(3) Take S₃={CP343(1)} out of switch_to_endpoint and search switch_to_switch for elements equivalent to {CP343(1)}. No element is found. Thus, put S₃={CP343(1)} back to the end of switch_to_endpoint.

At this time, switch_to_endpoint=[S₄={HP,CP343(2)}, S₅={1214}, S₆={S623}, S₁={CP443 (1),CP443(2)}, S₂={CP1543}, S₃={CP343(1)}] switch_to_switch=[S₁P₁={S623}, S₁P₂={1214,HP},S₂P₁={S623},S₂P₂={CP443 (1),CP443(2),1214,Hp}, S₃P₁={S623},S₃P₂={CP1543,CP443(1),CP443(2), 1214,HP}, S₄P₁={S623}, S₅P₁={S623}, S₅P₂={HP},S₆P₂={CP1543,CP343(1),CP443 (1),CP443(2),1214,HP}

(4) Take S₄={HP,CP343(2)} out of switch_to_endpoint and search switch_to_switch for elements equivalent to {HP,CP343(2)}. No element is found.

Thus, construct the subset of {HP,CP343(2)} in a decreasing sequence of the sizes of subsets and search switch_to_switch for the corresponding subset. Finally, a unique S₅P₂={HP} is found according to {HP}. Then, connect the switch S₄ to the port P₂ on the switch S₅ in the network topology.

Thus, S₅={1214,HP,CP343(2)} can be expanded into switch_to_endpoint.

Delete S₅P₂={HP} from switch_to_switch.

At this time, switch_to_endpoint=[S₅={1214,HP,CP343(2)}, S₆={S623}, S₁={CP443(1), CP443(2)}, S₂={CP1543}, S₃={CP343(1)}] switch_to_switch=[S₁P₁={S623},S₁P₂={1214,HP},S₂P₁={S623},S₂P₂={CP443 (1),CP443(2),1214,Hp}, S₃P₁={S623},S₃P₂={CP1543,CP443(1),CP443(2), 1214,HP},S₄P₁={S623}, S₅P₁={S623}, S₆P₂={CP1543,CP343(1),CP443(1),CP443 (2),1214,HP}]

(5) Take S₅={1214,HP,CP343(2)} out of switch_to_endpoint and search switch_to_switch for elements equivalent to {1214,HP,CP343(2)}. No element is found.

Thus, construct the subset of {1214,HP,CP343(2)} in a decreasing sequence of the sizes of subsets and search switch_to_switch for the corresponding subset. Finally, a unique S₁P₂={1214,HP} is found according to {1214,HP}. Then, connect the switch S₅ to the port P₂ on the switch S₁ in the network topology.

Thus, S₅={CP443(1),CP443(2),1214,HP,CP343(2)} can be expanded into switch_to_endpoint.

Delete S₁P₂={1214,HP} from switch_to_switch.

According to the operation described in step 5.5 of the algorithm, S₁ should be expanded and S₅ should be deleted. After the operations, the following are obtained: switch_to_endpoint=[S₆={S623}, S₁={CP443(1),CP443(2),1214,HP,CP343(2)}, S₂={CP1543},S₃={CP343(1)}]; switch_to_switch=[S₁P₁={S623}, S₂P₁={S623}, S₂P₂={CP443(1),CP443(2), 1214,HP},S₃P₁={S623}, S₃P₂={CP1543,CP443(1),CP443(2),1214,HP},S₄P₁={S623}, S₅P₁={S623}, S₆P₂={CP1543,CP343(1),CP443(1),CP443(2),1214,HP}];

(6) Take S₆={S623} out of switch_to_endpoint and search switch_to_switch for elements equivalent to {S623}. A plurality of elements:

S₁P₁={S623}, S₂P₁={S623}, S₃P₁={S623}, S₄P₁={S623}, S₅P₁={S623} are matched.

At this time, it is impossible to determine the connection relationship between switches according to S623. Thus, create an equivalence class set {S₁P₁={S623}, S₂P₁={S623}, S₃P₁={S623}, S₄P₁={S623}, S₅P₁={S623}56 , add it to the end of switch_to_endpoint, and delete S₁P₁={S623}, S₂P₁={S623}, S₃P₁={S623}, S₄P₁={S623}, S₅P₁={S623} from switch_to_switch.

According to the step described in section 5.2.3 of the algorithm, generate an equivalence class set {S₁P₁=S₆,S₂P₁=S₆, S₃P₁=S₆, S₄P₁=S₆,S₅P₁=S₆}. At this time, switch_to_endpoint=[S₁={CP443(1),CP443(2),1214,HP,CP343(2)}, S₂={CP 1543}, S₃={CP343 (1)}, {S₁P₁32 S₆, S₂P₁=S₆, S₃P₁=S₆, S₄P₁=S₆, S₅P₁=S₆}]; switch_to_switch=[S₂P₂={CP443(1),CP443(2),1214,HP}, S₃P₂={CP1543,CP 443(1),CP443(2),1214,HP},S₆P₂={CP1543,CP343(1),CP443(1),CP443(2), 1214,HP}];

(7) Take S₁={CP443(1),CP443(2),1214,HP,CP343(2)} out of switch_to_endpoint and search switch_to_switch for elements equivalent to {CP443(1),CP443(2),1214,HP,CP343(2)}. No element is found.

Thus, construct the subset of {CP443(1),CP443(2),1214,HP,CP343(2)} in a decreasing sequence of the sizes of subsets and search switch_to_switch for the corresponding subset. Finally, a unique element S₂P₂={CP443(1),CP443(2),1214,HP} is found according to {CP443(1),CP443(2),1214,HP}, then connect the switch S₁ to the port P₂ on the switch S₂ in the network topology.

Thus, S₂={CP443(1),CP443(2),1214,HP,CP343(2)} can be expanded into switch_to_endpoint.

Delete S₂P₂={CP443(1),CP443(2),1214,HP} from switch_to_switch.

At this time, switch_to_endpoint=[S₂={CP1543,CP443(1),CP443(2),1214,HP,CP343(2)}, S₃={CP343 (1)}, {S₁P₁=S₆, S₂P₁=S₆, S₃P₁=S₆, S₄P₁=S₆, S₅P₁=S₆}]; switch_to_switch=[S₃P₂={CP1543,CP443(1),CP443(2),1214,HP},S₆P₂={CP 1543,CP343(1),CP443(1),CP443(2),1214,HP}];

(8) Take S₂={CP1543,CP443(1),CP443(2),1214,HP,CP343(2)} out of switch_to_endpoint and search switch_to_switch for elements equivalent to {CP1543,CP443(1),CP443(2),1214,HP,CP343(2)}. No element is found.

Thus, construct the subset of {CP1543,CP443(1),CP443(2),1214,HP,CP343(2)} in a decreasing sequence of the sizes of subsets and search switch_to_switch for the corresponding subset. Finally, a unique element S₃P₂={CP1543,CP443(1),CP443(2),1214,HP} is found according to {CP1543,CP443(1),CP443(2),1214,HP}; then, connect the switch S₂ to the port P₂ on the switch S₃ in the network topology.

Thus, S₃={CP1543,CP443(1),CP443(2),1214,HP} can be expanded into switch_to_endpoint.

Delete S₂P₂={CP443(1),CP443(2),1214,HP} from switch_to_switch.

At this time, switch_to_endpoint=[S₃={CP1543,CP443(1),CP443(2),1214,HP,CP343(2), CP343 (1)}, {S₁P₁=S₆, S₂P₁=S₆, S₃P₁=S₆, S₄P₁=S₆, S₅P₁=S₆}]; switch_to_switch=[S₆P₂={CP1543,CP343(1),CP443(1),CP443(2),1214,HP}];

(9) Take S₃={CP1543,CP443(1),CP443(2),1214,HP,CP343(1)} out of switch_to_endpoint and search switch_to_switch for elements equivalent to {CP1543,CP443(1),CP443(2),1214,HP,CP343(1)}. A unique element S₆P₂={CP1543, CP343 (1) , CP443 (1) , CP443 (2) , 1214, HP} is matched. Then, connect the switch S₃ to the port P₂ on the switch S₆ in the network topology.

Thus, S₆={CP1543,CP343(1),CP443(1),CP443(2),1214,HP} can be expanded into switch_to_endpoint.

Delete S₆P₂={CP1543,CP343(1),CP443(1),CP443(2),1214,HP} from switch_to_switch.

So far, all switches have been connected to form a complete topology. The algorithm ends. The network topology obtained by the algorithm is completely consistent with the actual network topology.

### Embodiment 6

The network adopted in the present embodiment is the same as the one adopted in embodiment 5. FIG. 11 shows the network topology, wherein a circle represents a switch and a square represents a terminal device.

1. First initialize the network topology, as shown in FIG. 12.

2. Organize data in the MAC address tables of switch ports obtained through an SNMP detection to obtain list_of_mac_set shown in Table 4 in embodiment 5, and map it into symbols of corresponding devices (obtained through the SNMP detection).

3. Determine the connections of terminal devices. Similar to embodiment 5, determine the connections of terminal devices according to the following rules:

1) The terminal device connected to a port on a switch can be determined according to whether the MAC address table of the port on the switch contains a plurality of MAC addresses corresponding to the same device.

2) It can be determined that a terminal device is not directly connected to a port on the first switch by determining whether the MAC address table of the port on the switch contains the MAC address of the terminal device (for example, 5623) and MAC addresses of ports on other switches.

Accordingly, the network topology shown in FIG. 13 can be derived.

4. Remove all MAC addresses other than MAC addresses of switch ports from list_of_mac_set, including:

1) MAC addresses of terminal devices;

2) MAC address of the management port of switches;

3) other unrelated MAC addresses.

Then obtain the list_of_mac_set shown in Table 6.

TABLE 6

| Switch | Port | MACaddressset | |
|---|---|---|---|
| S₁ | P₁ | 00-1B-1B-91-6b-DE | S4P2 |
| | | 00-1B-1B-91-6c-01 | S2P2 |
| | P₂ | 00-1B-1B-91-6B-DD | S4P1 |
| | | 00-1B-1B-91-6B-FB | S5P1 |
| | P₃ | | |
| | P₄ | | |
| S₂ | P₁ | 00-1B-1B-91-6B-DE | S4P2 |
| | | 00-1B-1B-91-6B-ED | S3P2 |
| | P₂ | 00-1B-1B-91-6B-DD | S4P1 |
| | | 00-1B-1B-91-6B-E7 | S1P1 |
| | P₃ | | |
| | P₄ | | |
| S₃ | P₁ | 00-1B-1B-91-6B-DE | S4P2 |
| | | 00-1B-1B-91-6B-E3 | S6P2 |
| | P₂ | 00-1B-1B-91-6B-DD | S4P1 |
| | | 00-1B-1B-91-6C-00 | S2P1 |
| | P₃ | | |
| | P₄ | | |
| S₄ | P₁ | 00-1B-1B-91-6B-FC | S5P2 |
| | P₂ | | |
| | P₃ | | |
| | P₄ | | |
| S₅ | P₁ | 00-1B-1B-91-6B-DE | S492 |
| | | 00-1B-1B-91-6B-E8 | S1P2 |
| | P₂ | 00-1B-1B-91-6B-DD | S4P1 |
| | P₃ | | |
| | P₄ | | |
| S₆ | P₁ | 00-1B-1B-91-6B-DE | S4P2 |
| | P₂ | 00-1B-1B-91-6B-DD | S4P1 |
| | | 00-1B-1B-91-6B-EC | S3P1 |
| | P₃ | | |
| | P₄ | | |

5. Derive the connection relationship between switches according to the MAC addresses in the MAC address table of each port on each switch.

According to the list_of_mac_set, it can be derived that the connection relationship between switches is as follows:

1) First analyze the MAC addresses of the ports on the switch S₁. It is found that the MAC address tables of the port P₁ and the port P₂ both contain the MAC address of the switch S₄. Usually, this situation will not appear. Thus, it can be determined that the switch S₄ is a management node (redundancy manager) of the ring network and the MAC addresses of the ports on the switch can be removed.

According to the remaining MAC addresses, it can directly be inferred that the port P₁ on the switch S₁ is connected to the port P₂ on the switch S₂, and the port P₂ on the switch S₁ is connected to the port P₁ on the switch S₅.

2) Similarly, remove the MAC addresses of the ports on the switch S₄ from the MAC address tables of ports on the switch S₂. According to the remaining MAC addresses, it can directly be inferred that: the port P₁ on the switch S₂ is connected to the port P₂ on the switch S₂, and the port P₂ on the switch S₂ is connected to the port P₁ on the switch S₁.

3) Similarly, remove the MAC addresses of the ports on the switch S₄ from the MAC address tables of ports on the switch S₃. According to the remaining MAC addresses, it can directly be inferred that the port P₁ on the switch S₃ is connected to the port P₂ on the switch S₆, and the port P₂ on the switch S₃ is connected to the port P₁ on the switch S₂.

4) For the MAC address tables of the ports on the switch S₄, which is a management switch, it can directly be inferred according to the MAC addresses on the ports that the port P₁ on the switch S₄ is connected to the port P₂ on the switch S₅.

5) Similarly, remove the MAC addresses of the ports on the switch S₄ from the MAC address tables of ports on the switch S₅. According to the remaining MAC addresses, it can directly be inferred that the port P₁ on the switch S₅ is connected to the port P₂ on the switch S₁, and in addition, it can be learned from step 4) that the port P₂ on the switch S₅ is connected to the port P₁ on the switch S₄.

6) Similarly, remove the MAC addresses of the ports on the switch S₄ from the MAC address tables of ports on the switch S₆. According to the remaining MAC addresses, it can directly be inferred that the port P₂ on the switch S₆ is connected to the port P₁ on the switch S₃.

So far, all switches have been connected to form a complete topology. The algorithm ends. The network topology obtained by the algorithm is completely consistent with the actual network topology.

In addition, when the MAC address table of each port on each switch is acquired from a target network, the MAC address table of each port on each switch in the target network can be acquired from a switch at the convergence layer and/or core layer of the target network.

Switches in a network may be classified into access layer switches, convergence layer switches and core layer switches. Access layer switches are used to connect terminal devices, convergence layer switches are used to connect access layer switches or terminal devices, and core layer switches are used to connect convergence layer switches or terminal devices. Usually, the number of access layer switches is greater than the number of convergence layer switches, and the number of convergence layer switches is greater than the number of core layer switches.

When the MAC address table of a port on a switch is acquired from a switch at the access layer of a network, it is necessary to deploy a probe on each of the switches S1-S6, as shown in FIG. 13. Then, the deployed probes are utilized to acquire the MAC address table of each port on each switch at the access layer.

When the MAC address table of a port on a switch is acquired from a switch at the convergence layer of a network, it is necessary to deploy a probe on each of the switches S7-S9, as shown in FIG. 7. Then, the deployed probes are utilized to acquire the MAC address table of each port on each switch at the convergence layer and the access layer.

When the MAC address table of a port on a switch is acquired from a switch at the core layer of a network, it is necessary to deploy a probe only on the switch S10, as shown in FIG. 7. Then, the deployed probe is utilized to acquire the MAC address table of each port on each switch at the core layer, the convergence layer and the access layer.

From the above-mentioned comparative analysis, it can be learned that, if the MAC address table of each port on each switch is acquired from a switch at the convergence layer and/or the core layer, but not from a switch at the access layer, a probe needs to be deployed on a smaller number of switches so that the MAC address table of each port on each switch in a target network can be acquired. Thus, it is more convenient to acquire MAC address tables and meanwhile the cost of acquiring MAC address tables is also lowered.

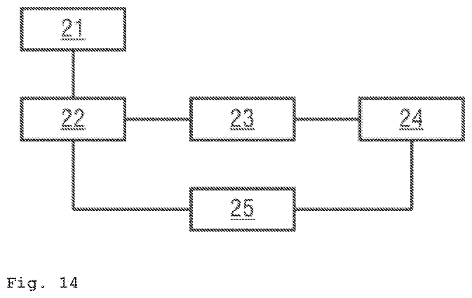

As shown in FIG. 14, the network topology construction apparatus provided by one embodiment of the present invention comprises: a table acquisition module 21, used to acquire a MAC address table of each port on each switch in a target network, wherein the target network comprises at least two switches and at least one terminal device; a first relationship determination module 22, used to determine a first connection relationship in the target network according to the MAC addresses of terminal devices in the target network that are included in each MAC address table acquired by the table acquisition module 21, wherein the first connection relationship is used to represent a connection relationship between terminal devices and switches in a network; a port screening module 23, used to determine at least one first port according to the first connection relationship determined by the first relationship determination module 22 in the target network, wherein the first port is a port connected with no terminal device on each switch in the target network; a second relationship determination module 24, used to determine a second connection relationship in the target network according to the MAC addresses included in the MAC address table of each first port determined by the port screening module 23 in the target network, wherein the second connection relationship is used to represent a connection relationship between switches in a network; a topology construction module 25, used to determine a network topology of the target network according to the first connection relationship determined by the first relationship determination module 22 and the second connection relationship determined by the second relationship determination module 24 in the target network.

In some embodiments, the table acquisition module 21 can be used to execute step 101 in the embodiment of the above-mentioned method, the first relationship determination module 22 can be used to execute step 102 in the embodiment of the above-mentioned method, the port screening module 23 can be used to execute step 103 in the embodiment of the above-mentioned method, the second relationship determination module 24 can be used to execute step 104 in the embodiment of the above-mentioned method, and the topology construction module 25 can be used to execute step 105 in the embodiment of the above-mentioned method.

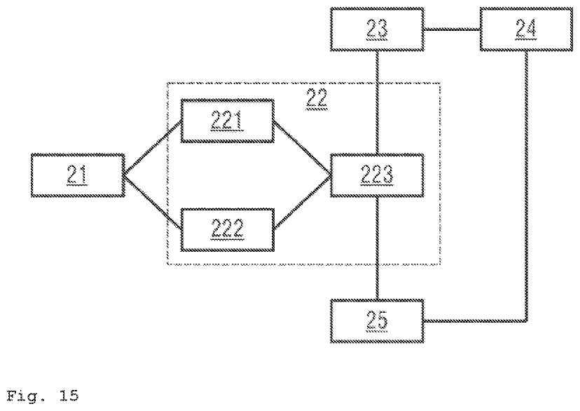

In some embodiments, on the basis of the network topology construction apparatus shown in FIG. 14, as shown in FIG. 15, the first relationship determination module 22 comprises: a first matching unit 221, used for each MAC address table acquired by the table acquisition module 21 to determine that the port which the MAC address table belongs to is connected to a first terminal device if the MAC address table contains only one MAC address of the first terminal device in the target network and no other acquired MAC address tables containing MAC addresses completely the same as the MAC addresses in the MAC address table exist;

a second matching unit 222, used for each MAC address table acquired by the table acquisition module 21 to determine that the port which the MAC address table belongs to is connected to a second terminal device in the target network if the MAC address table contains at least two MAC addresses of the second terminal device;

an integration unit 223, used to determine a first connection relationship in the target network according to the connection relationship determined by the first matching unit 221 and the second matching unit 222 between terminal devices and ports of the switches in the target network and the ports included in each switch in the target network.

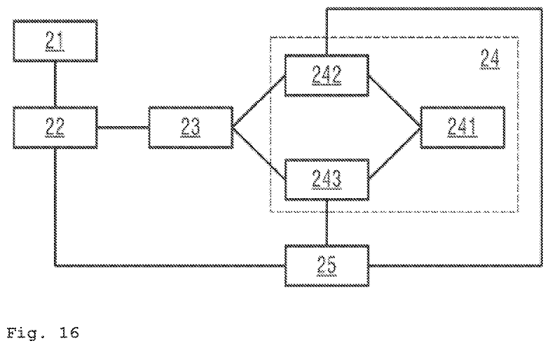

In some embodiments, on the basis of the network topology construction apparatus shown in FIG. 14, as shown in FIG. 16, the second relationship determination module 24 comprises:

a determination unit 241, used to determine whether each port on each switch in the target network has a MAC address;

a first relationship determination unit 242, used to determine the second connection relationship in the target network according to the MAC addresses of the ports of the switches in the target network that are included in the MAC address table of each of the first ports in the target network if the determination unit 241 determines that each port on each switch in the target network has a MAC address;

a second relationship determination unit 243, used to determine the second connection relationship in the target network according to the MAC addresses of terminal devices included in the MAC address table of each of the first ports in the target network if the determination unit 241 determines that at least one port on each switch in the target network has no MAC address.

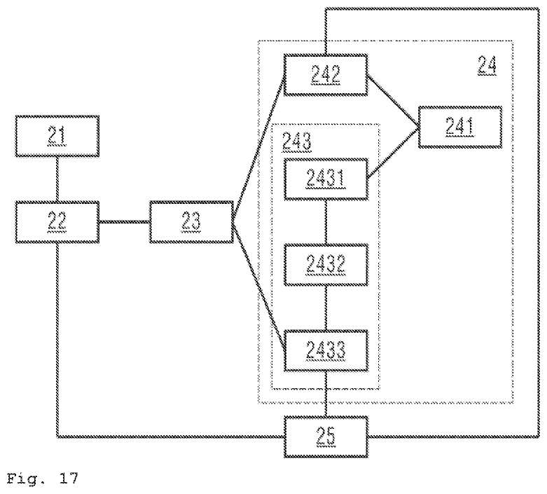

In some embodiments, on the basis of the network topology construction apparatus shown in FIG. 16, as shown in FIG. 17, the second relationship determination unit 243 comprises: an address deletion subunit 2431, used for any switch in the target network to determine that the switch is a redundancy manager in the target network and delete the MAC addresses of all ports on the switch from the MAC address table of each first port if the MAC addresses of at least two ports on the switch are in the MAC address table of the same port on another switch in the target network;

a first relationship determination subunit 2432, used for each of the first ports in the target network to determine that the first port is connected with a second port if the MAC address table of the first port contains a MAC address of the second port in the target network, wherein the first port and the second port are located on different switches in the target network;

a first integration subunit 2433, used to determine the second connection relationship in the target network according to the connection relationship determined by the first relationship determination subunit 2432 between each of the first ports and the second port in the target network and the switches the first port and the second port belong to.

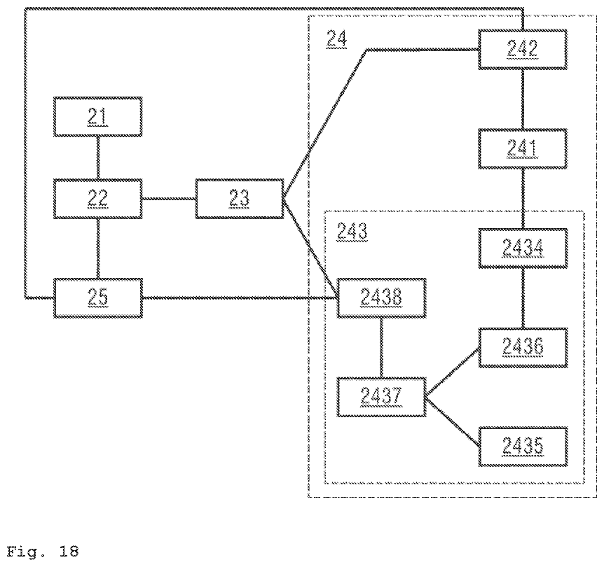

In some embodiments, on the basis of the network topology construction apparatus shown in FIG. 16, as shown in FIG. 18, the second relationship determination unit 243 comprises:

a port screening subunit 2434, used for each of the first ports in the target network to screen a third port out of first ports other than the first port in the target network, wherein the MAC address table of the third port and the MAC address table of the first port contain at least one identical MAC address;

a first set construction subunit 2435, used for each of the first ports in the target network to acquire a corresponding first MAC address set of the first port, wherein the elements in the first MAC address set are MAC addresses of terminal devices in the MAC address table of the first port;

a second set construction subunit 2436, used for each of the third ports screened out by the port screening subunit 2434 to acquire a corresponding second MAC address set of the third port, wherein the elements in the second MAC address set are MAC addresses of terminal devices in the MAC address table of the third port;

a second relationship determination subunit 2437, used to determine the connection relationship between the first port and the third port according to the inclusion relationship between the first MAC address set acquired by the first set construction subunit 2435 and each of the second MAC address sets acquired by the second set construction subunit 2436 and the inclusion relationship between the subsets of the first MAC address set acquired by the first set construction subunit 2435 and each of the second MAC address sets acquired by the second set construction subunit 2436;

a second integration subunit 2438, used to determine the second connection relationship in the target network according to the connection relationship determined by the second relationship determination subunit 2437 between each of the first ports and the third port in the target network and the switches the first port and the third port belong to.

In some embodiments, on the basis of the network topology construction apparatus shown in any of FIGS. 14 to 18, the table acquisition module 21 is used to acquire a MAC address table of each port on each switch in the target network from a switch at the convergence layer and/or core layer of the target network, wherein a switch located at the core layer of the target network is connected with a switch located at the convergence layer of the target network, a switch located at the convergence layer of the target network is connected with a switch located at the access layer of the target network, and a switch located at the access layer of the target network is connected with terminal devices.

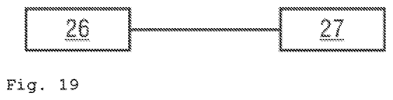

As shown in FIG. 19, a network topology construction apparatus provided by one embodiment of the present invention comprises at least one memory 26 and at least one processor 27, wherein the at least one memory 26 is configured to store executable instructions, and the at least one processor 27 is coupled with the at least one memory 26, and when executing the executable instructions, the at least one processor is configured to: acquire a MAC address table of each port on each switch in a target network, wherein the target network comprises at least two switches and at least one terminal device; determine a first connection relationship in the target network according to the MAC addresses of terminal devices in the target network that are included in each acquired MAC address table, wherein the first connection relationship is used to represent a connection relationship between terminal devices and switches in a network; determine at least one first port according to the first connection relationship in the target network, wherein the first port is a port connected with no terminal device on each switch in the target network; determine a second connection relationship in the target network according to the MAC addresses included in the MAC address table of each of the first ports in the target network, wherein the second connection relationship is used to represent a connection relationship between switches in a network; and determine a network topology of the target network according to the first connection relationship and the second connection relationship in the target network.

In some embodiments, on the basis of the network topology construction apparatus shown in FIG. 19, after executing the executable instructions, the at least one processor 27 is further configured to: for each acquired MAC address table, perform the following: if the MAC address table contains only one MAC address of a first terminal device in the target network and no other acquired MAC address tables containing MAC addresses completely the same as the MAC addresses in the MAC address table exist, determine that the port which the MAC address table belongs to is connected with the first terminal device; if the MAC address table contains at least two MAC addresses of a second terminal device in the target network, determine that the port which the MAC address table belongs to is connected with the second terminal device; and determine a first connection relationship in the target network according to the connection relationship between terminal devices and the ports of the switches in the target network and the ports included in each switch in the target network.

In some embodiments, on the basis of the network topology construction apparatus shown in FIG. 19, after executing the executable instructions, the at least one processor 27 is further configured to: determine whether each port on each switch in the target network has a MAC address; if each port on each switch in the target network has a MAC address, determine the second connection relationship in the target network according to the MAC addresses of the ports of the switches that are included in the MAC address table of each of the first ports in the target network; and if at least one port on each switch in the target network has no MAC address, determine the second connection relationship in the target network according to the MAC addresses of terminal devices included in the MAC address table of each of the first ports in the target network.

In some embodiments, on the basis of the network topology construction apparatus shown in FIG. 19, after executing the executable instructions, the at least one processor 27 is further configured to: for any switch in the target network, if the MAC addresses of at least two ports on the switch are in the MAC address table of the same port on another switch in the target network, determine that the switch is a redundancy manager in the target network and delete the MAC addresses of all ports on the switch from the MAC address table of each first port; for each of the first ports in the target network, if the MAC address table of the first port contains a MAC address of a second port in the target network, determine that the first port is connected with the second port, wherein the first port and the second port are located on different switches in the target network; and determine the second connection relationship in the target network according to the connection relationship between each of the first ports and the second port in the target network and the switches the first port and the second port belong to.

In some embodiments, on the basis of the network topology construction apparatus shown in FIG. 19, after executing the executable instructions, the at least one processor 27 is further configured to: for each of first ports in the target network, perform the following: screen a third port out of first ports other than the first port in the target network, wherein the MAC address table of the third port and the MAC address table of the first port contain at least one identical MAC address; acquire a corresponding first MAC address set of the first port, wherein the elements in the first MAC address set are MAC addresses of terminal devices in the MAC address table of the first port; for each of the third ports, acquire a corresponding second MAC address set of the third port, wherein the elements in the second MAC address set are MAC addresses of terminal devices in the MAC address table of the third port; determine the connection relationship between the first port and the third port according to the inclusion relationship between the first MAC address set and each of the second MAC address sets and the inclusion relationship between the subsets of the first MAC address set and each second MAC address set; and determine the second connection relationship in the target network according to the connection relationship between each of the first ports and the third port in the target network and the switches the first port and the third port belong to.

In some embodiments, on the basis of the network topology construction apparatus shown in FIG. 19, after executing the executable instructions, the at least one processor 27 is further configured to: acquire a MAC address table of each port on each switch in the target network from a switch at the convergence layer and/or core layer of the target network, wherein a switch located at the core layer of the target network is connected with a switch located at the convergence layer of the target network, a switch located at the convergence layer of the target network is connected with a switch located at the access layer of the target network, and a switch located at the access layer of the target network is connected with terminal devices.

In some embodiments, a computer-readable medium stores instructions used to allow a machine to execute the network topology construction method described in this document. Specifically, a system or device may be equipped with a storage medium. Software program codes which can realize the function in any of the above-mentioned embodiments are stored in the storage medium and the computer (or CPU or MPU) of the system or device can read and execute the program codes stored in the storage medium.

In some embodiments, program codes read from the storage medium themselves can realize the function in any of the above-mentioned embodiments. Therefore, program codes and the storage medium where program codes are stored constitute a part of the teachings herein.

Embodiments of the storage medium used to provide program codes include a floppy disk, hard disk, magneto-optical disk, compact disk (for example, compact disk read-only memory (CD-ROM), compact disk-recordable (CD-R), compact disk-rewritable (CD-RW), digital video disk-read only memory (DVD-ROM), digital versatile disk-random access memory (DVD-RAM), digital versatile disk-rewritable (DVD-RW), digital versatile disk plus rewritable (DVD+RW), magnetic tape, non-volatile memory card, and read-only memory (ROM). Alternatively, the program codes may be downloaded from a server computer over a communication network.

In some embodiments, the function of any of the above-mentioned embodiments can be realized not only by executing the program codes read out by a computer, but also by allowing the operating system running on the computer to complete a part or all of practical operations through program code based instructions.

In some embodiments, the program codes read out of a storage medium are written into the memory in the expansion board in a computer or are written into a memory in an expansion module connected to the computer, and then the program code-based instructions allow the CPU installed on the expansion board or expansion module to execute a part or all of the practical operations to realize the function of any of the above-mentioned embodiments.

In some embodiments, not all steps or modules in the above-mentioned flowcharts and system structure diagrams are required, and some steps or modules can be omitted, depending on the actual requirements. The execution sequence of the steps is not fixed and may be adjusted as required. The system structures described in the above-mentioned embodiments can be physical structures or logical structures. That is to say, some modules may be realized by a physical entity, or some modules may be realized by a plurality of physical entities or may jointly be realized by some components in a plurality of self-contained devices.

In some embodiments, hardware modules can mechanically or electrically be realized. For example, a hardware module can comprise a permanent dedicated circuit or logic (for example, special processor, FPGA, or ASIC) to complete the corresponding operations. A hardware module can further comprise a programmable logic or circuit (for example, a general processor or other programmable processor) and can complete the corresponding operations through temporary software setting. The specific implementation mode (mechanical mode, or dedicated permanent circuit, or circuit which is temporarily set) can be determined on the basis of consideration of cost and time.

The teachings of the present disclosure have been revealed and described in detail above in combination with the drawings and example embodiments. However, the scope of the present disclosure is not limited to the disclosed embodiments. On the basis of the plurality of above-mentioned embodiments, those skilled in the art can know that more embodiments of the present disclosure can be obtained by combining the code review means in the above-mentioned different embodiments, and all these embodiments should also fall within the scope of protection of the present disclosure.

What is claimed is:

1. A network topology construction method comprising:
acquiring a MAC address table of each port on each switch in a target network, wherein the target network comprises at least two switches and at least one terminal device;
determining a first connection relationship in the target network according to the MAC addresses of terminal devices in the target network included in each acquired MAC address table, wherein the first connection relationship represents a connection relationship between terminal devices and switches included in a network;
determining at least one first port according to the first connection relationship in the target network, wherein the first port is a port connected with no terminal device on each switch in the target network;
determining a second connection relationship in the target network according to the MAC addresses included in the MAC address table of each of the first ports in the target network, wherein the second connection relationship represents a connection relationship between switches in a network; and
determining a network topology of the target network according to the first connection relationship and the second connection relationship in the target network.

2. The method as claimed in claim 1, wherein determining a first connection relationship in the target network according to the MAC addresses of the terminal devices in the target network that are included in each acquired MAC address table comprises,
for each acquired MAC address table, performing the following:
if the MAC address table contains only one MAC address of a first terminal device in the target network and no other acquired MAC address tables containing MAC addresses completely the same as the MAC addresses included in the MAC address table exist, determining that the port which the MAC address table belongs to is connected with the first terminal device;
if the MAC address table contains at least two MAC addresses of a second terminal device in the target network, determining that the port which the MAC address table belongs to is connected with the second terminal device; and
determining a first connection relationship in the target network according to the connection relationship between terminal devices and ports on the switches in the target network and the ports included in each switch in the target network.

3. The method as claimed in claim 1, wherein determining a second connection relationship in the target network according to the MAC addresses included in the MAC address table of each of the first ports in the target network comprises:
determining whether each port on each switch in the target network has a MAC address;
if each port on each switch in the target network has a MAC address, determining the second connection relationship in the target network according to the MAC addresses of the ports of the switches included in the MAC address table of each of the first ports in the target network; and
if at least one port on each switch in the target network has no MAC address, determining the second connection relationship in the target network according to the MAC addresses of terminal devices included in the MAC address table of each of the first ports in the target network.

4. The method as claimed in claim 3, wherein determining a second connection relationship in the target network according to the MAC addresses of the ports of the switches included in the MAC address table of each of the first ports in the target network comprises:
for any switch in the target network, if the MAC addresses of at least two ports on the switch are in the MAC address table of the same port on another switch in the target network, determining that the switch is a redundancy manager in the target network and deleting the MAC addresses of all ports on the switch from the MAC address table of each first port;
for each of the first ports in the target network, if the MAC address table of the first port contains a MAC address of a second port in the target network, determining that the first port is connected with the second port, wherein the first port and the second port are located on different switches in the target network; and
determining the second connection relationship in the target network according to the connection relationship between each of the first ports and the second port in the target network and the switches the first port and the second port belong to.

5. The method as claimed in claim 3, wherein determining a second connection relationship in the target network according to the MAC addresses of terminal devices included in the MAC address table of each of the first ports in the target network comprises,
for each of the first ports in the target network, performing the following:
screening a third port out of first ports other than the first port in the target network, wherein the MAC address table of the third port and the MAC address table of the first port contain at least one identical MAC address;
acquiring a corresponding first MAC address set of the first port, wherein the elements in the first MAC address set are MAC addresses of terminal devices in the MAC address table of the first port;
for each of the third ports, acquiring a corresponding second MAC address set of the third port, wherein the elements in the second MAC address set are MAC addresses of terminal devices in the MAC address table of the third port;
determining the connection relationship between the first port and the third port according to the inclusion relationship between the first MAC address set and each of the second MAC address sets and the inclusion relationship between the subsets of the first MAC address set and each of the second MAC address sets; and
determining the second connection relationship in the target network according to the connection relationship between each of the first ports and the third port in the target network and the switches the first port and the third port belong to.

6. The method as claimed in claim 1, wherein acquiring a MAC address table of each port on each switch in a target network comprises
acquiring a MAC address table of each port on each switch in the target network from a switch at the convergence layer and/or core layer of the target network, wherein a switch located at the core layer of the target network is connected with a switch located at the convergence layer of the target network, a switch located at the convergence layer of the target network is connected with a switch located at the access layer of the target network, and a switch located at the access layer of the target network is connected with terminal devices.

7. A network topology construction apparatus comprising:
a table acquisition module to acquire a MAC address table of each port on each switch in a target network, wherein the target network comprises at least two switches and at least one terminal device;
a first relationship determination module to determine a first connection relationship in the target network according to the MAC addresses of terminal devices in the target network that are included in each MAC address table acquired by the table acquisition module, wherein the first connection relationship is used to represent a connection relationship between terminal devices and switches in a network;
a port screening module to determine at least one first port according to the first connection relationship determined by the first relationship determination module in the target network, wherein the first port is a port connected with no terminal device on each switch in the target network;
a second relationship determination module to determine a second connection relationship in the target network according to the MAC addresses included in the MAC address table of each of first ports determined by the port screening module in the target network, wherein the second connection relationship is used to represent a connection relationship between switches in a network; and
a topology construction module to determine a network topology of the target network according to the first connection relationship determined by the first relationship determination module and the second connection relationship determined by the second relationship determination module in the target network.

8. The apparatus as claimed in claim 7, wherein the first relationship determination module comprises:
a first matching unit for each MAC address table acquired by the table acquisition module to determine that the port which the MAC address table belongs to is connected with a first terminal device if the MAC address table contains only one MAC address of the first terminal device in the target network and no other acquired MAC address tables containing MAC addresses completely the same as the MAC addresses included in the MAC address table exist;
a second matching unit for each MAC address table acquired by the table acquisition module to determine that the port which the MAC address table belongs to is connected with a second terminal device in the target network if the MAC address table contains at least two MAC addresses of the second terminal device; and
an integration unit to determine a first connection relationship in the target network according to the connection relationship determined by the first matching unit and the second matching unit between terminal devices and ports of the switches in the target network and the ports included in each switch in the target network.

9. The apparatus as claimed in claim 7, wherein the second relationship determination module comprises:
a determination unit to determine whether each port on each switch in the target network has a MAC address;
a first relationship determination unit to determine the second connection relationship in the target network according to the MAC addresses of the ports of the switches included in the MAC address table of each of the first ports in the target network if the determination unit determines that each port of each switch in the target network has a MAC address; and
a second relationship determination unit to determine the second connection relationship in the target network according to the MAC addresses of terminal devices included in the MAC address table of each of the first ports in the target network if the determination unit determines that at least one port of each switch in the target network has no MAC address.

10. The apparatus as claimed in claim 9, wherein the second relationship determination unit comprises:
an address deletion subunit for any switch in the target network to determine that the switch is a redundancy manager in the target network and delete the MAC addresses of all ports on the switch from the MAC address table of each first port if the MAC addresses of at least two ports on the switch are in the MAC address table of the same port on another switch in the target network;
a first relationship determination subunit for each of the first ports in the target network to determine that the first port is connected with a second port if the MAC address table of the first port contains a MAC address of the second port in the target network, wherein the first port and the second port are located on different switches in the target network; and
a first integration subunit to determine the second connection relationship in the target network according to the connection relationship determined by the first relationship determination subunit between each of the first ports and the second port in the target network and the switches the first port and the second port belong to.

11. The apparatus as claimed in claim 9, wherein the second relationship determination unit comprises:
a port screening subunit for each of the first ports in the target network to screen a third port out of first ports other than the first port in the target network, wherein the MAC address table of the third port and the MAC address table of the first port contain at least one identical MAC address;
a first set construction subunit for each of first ports in the target network to acquire a corresponding first MAC address set of the first port, wherein the elements in the first MAC address set are MAC addresses of terminal devices in the MAC address table of the first port;
a second set construction subunit for each of the third ports screened out by the port screening subunit to acquire a corresponding second MAC address set of the third port, wherein the elements in the second MAC address set are MAC addresses of terminal devices in the MAC address table of the third port;
a second relationship determination subunit to determine the connection relationship between the first port and the third port according to the inclusion relationship between the first MAC address set acquired by the first set construction subunit and each of the second MAC address sets acquired by the second set construction subunit and the inclusion relationship between the subsets of the first MAC address set acquired by the first set construction subunit and each of the second MAC address sets acquired by the second set construction subunit; and
a second integration subunit to determine the second connection relationship in the target network according to the connection relationship determined by the second relationship determination subunit between each of the first ports and the third port in the target network and the switches the first port and the third port belong to.

12. The apparatus as claimed in claim 7, wherein
the table acquisition module acquires a MAC address table of each port on each switch in the target network from a switch at the convergence layer and/or core layer of the target network, wherein a switch located at the core layer of the target network is connected with a switch located at the convergence layer of the target network, a switch located at the convergence layer of the target network is connected with a switch located at the access layer of the target network, and a switch located at the access layer of the target network is connected with terminal devices.

13. A network topology construction apparatus, further comprising a memory and a processor;
wherein
the memory stores a machine-readable program to: machine-readable program to:
acquire a MAC address table of each port on each switch in a target network, wherein the target network comprises at least two switches and at least one terminal device;
determine a first connection relationship in the target network according to the MAC addresses of terminal devices in the target network included in each acquired MAC address table, wherein the first connection relationship represents a connection relationship between terminal devices and switches included in a network;
determine at least one first port according to the first connection relationship in the target network, wherein the first port is a port connected with no terminal device on each switch in the target network;
determine a second connection relationship in the target network according to the MAC addresses included in the MAC address table of each of the first ports in the target network, wherein the second connection relationship represents a connection relationship between switches in a network; and
determine a network topology of the target network according to the first connection relationship and the second connection relationship in the target network.

14. (canceled)
